(19) United States
(12) Patent Application Publication
(10) Pub. No.: US 2015/0198938 A1
(43) Pub. Date: Jul. 16, 2015

(54) SYSTEMS, DEVICES, METHODS AND GRAPHICAL USER INTERFACE FOR CONFIGURING A BUILDING AUTOMATION SYSTEM

(71) Applicant: Green Edge Technologies, Inc., Poway, CA (US)

(72) Inventors: Scott A. STEELE, Poway, CA (US); William P. ALBERTH, JR., Prairie Grove, IL (US); Joshua E. CAMPBELL, Chicago, IL (US); Jody L. CAMPBELL, Chicago, IL (US); William D. RICE, San Diego, CA (US); David K. HARTSFIELD, Poway, CA (US)

(73) Assignee: Green Edge Technologies, Inc., Poway, CA (US)

(21) Appl. No.: 14/155,807

(22) Filed: Jan. 15, 2014

(51) Int. Cl. G05B 15/02; H04L 12/28

(52) U.S. Cl. CPC G05B 15/02; H04L 12/2803

(57) ABSTRACT

Systems and methods are provided for configuring an automation system. A parameter for a building in which an automation system is to be installed is obtained. Configuration information is obtained for properly configuring components of the automation system in accordance with a parameter for the building. It is determined whether or not each of the components of the automation system being installed within the building is properly configured based on the obtained configuration information and input received from a user indicating the locations of the respective components within the building. A notification is provided to the user, which indicates the results of the determination for one or more of the components, and the user is presented with options for modifying configuration settings for one or more of the components.

### FIELD OF THE INVENTION

Embodiments of the present disclosure are generally directed to systems, devices, and methods for configuring a building automation system. More particularly, embodiments of the present disclosure are directed to systems, devices, and methods for configuring newly installed components of a building automation system.

### BACKGROUND OF THE INVENTION

Many components of a building automation system may be deployed and installed at the construction site during the initial construction of a building (e.g., a home or other type of residential or nonresidential structure). For example, the installation process for a home automation system generally involves the collection of serial numbers or other unique identification information for each home automation device or component to be installed. Other information that may be collected includes the location and function of the devices to be installed within the building. Once installed, the devices also will need to be configured based on a set of initial specifications that may be determined by, for example, the builder or architect, or a user trying to implement a desired functionality.

Although most buildings are built to blueprints, it is common for the building's construction to be adjusted to account for individual circumstances forcing on site modifications to the plans. As such, the installation process for a building automation system during construction must be sufficiently flexible to allow for changes that occur at the construction site. However, conventional solutions for installing and configuring building automation systems for commercial or residential buildings fail to provide an efficient way for builders or their affiliated installation service providers to manage, track, and deploy the various components and devices of a building automation system to be installed throughout a building during its construction.

Thus, there is a need to enable efficient and flexible setup and configuration of a building automation system to be installed and deployed during construction of the building.

### SUMMARY OF THE INVENTION

The present disclosure is generally directed toward improving functionality of an automation system by enabling setup of the system during installation and configuration. In one embodiment, a method for configuring a building automation system is disclosed. In some embodiments, the method may include: obtaining a parameter for a building in which an automation system is to be installed within the building; receiving input for configuring a first component of the automation system and a second component of the automation system being installed, the input including a first location for installing the first component and a second location for installing the second component within the building; identifying each of the first and second components of the automation system based on the input received; obtaining configuration information for properly configuring each of the identified first and second components of the automation system being installed in accordance with the obtained parameter for the building; determining whether or not each of the first and second components of the automation system being installed within the building is properly configured based on the obtained configuration information and the input received indicating the first and second location of the respective first and second components; and providing a notification indicating results of the determination for one or more of the first and second components, wherein options for modifying configuration settings for one or more of the first and second components are presented.

Various embodiments of the method may include one or more of the following features: receiving additional input from a user for configuring a third component of the automation system to be installed within the building; identifying the third component of the automation system based on the additional input received from the user; obtaining configuration information for properly configuring the identified third component of the automation system based at least in part on the parameter obtained for the building; wherein the obtained configuration information for the third component specifies an association between the third component and the first component of the automation system, and the method further includes determining whether the first and third components of the automation system are properly configured based on the obtained configuration information and the input received from the user for configuring each of the first and third components and providing the user with a notification indicating results of the determination for the first and third components; comparing the obtained configuration information for the third component with the input received from the user for configuring the third component; determining whether or not the association between the first and third components is configured properly based on the comparison; wherein the parameter for the building is included within a digital blueprint for the building, the digital blueprint indicating proper locations for the first and second components to be installed within the building; displaying a graphical representation of the digital blueprint to the user via a display device coupled to a mobile device of the user, the graphical representation including visual indicators representing the first and second components at positions corresponding to the proper locations of the first and second components to be installed within the building; wherein the graphical representation of the digital blueprint displayed to the user includes a visual indication of the user's current position within the building; wherein the visual indication of the user's current position is based on a current geographic location of the user's mobile device within the building, wherein the current geographic location of the user's mobile device is based on location data derived from one or more sensors of the user's mobile device; wherein the input from the user includes a first identifier for the first component and a second identifier for the second component; wherein each of the first and second identifiers is an electronic serial number corresponding to each of the first and second components; wherein the electronic serial number for each of the first and second components is based on identifier information captured by the user's mobile device using one or more input devices coupled to the user's mobile device; and wherein the one or more input devices include a touchscreen display, an infrared (IR) scanner, a digital camera, an RFID tag reader, and an NFC tag reader.

In another embodiment, a system for configuring a building automation system is disclosed. The system includes a memory having processor-readable instructions stored therein and a processor configured to access the memory and execute the processor-readable instructions, which when executed by the processor cause the processor to perform a plurality of functions, including functions to: obtain a parameter for a building in which an automation system is to be installed by a user within the building; receive input from the user for configuring a first component of the automation system and a second component of the automation system being installed, the input including a first location for installing the first component and a second location for installing the second component within the building; identify each of the first and second components of the automation system based on the input received from the user; obtain configuration information for properly configuring each of the identified first and second components of the automation system being installed in accordance with the obtained parameter for the building; determine whether or not each of the first and second components of the automation system being installed within the building is properly configured based on the obtained configuration information and the input received from the user indicating the first and second location of the respective first and second components; and provide the user with a notification indicating results of the determination for one or more of the first and second components, wherein the user is presented with options for modifying configuration settings for one or more of the first and second components.

Various embodiments of the system may include one or more functions to: receive additional input from the user for configuring a third component of the automation system to be installed within the building; identify the third component of the automation system based on the additional input received from the user; obtain configuration information for properly configuring the identified third component of the automation system based at least in part on the parameter obtained for the building; wherein the obtained configuration information for the third component specifies an association between the third component and the first component of the automation system, and the processor is further configured to perform functions to determine whether the first and third components of the automation system are properly configured based on the obtained configuration information and the input received from the user for configuring each of the first and third components and provide the user with a notification indicating results of the determination for the first and third components; compare the obtained configuration information for the third component with the input received from the user for configuring the third component; determine whether or not the association between the first and third components is configured properly based on the comparison; wherein the parameter for the building is included within a digital blueprint for the building, the digital blueprint indicating proper locations for the first and second components to be installed within the building; display a graphical representation of the digital blueprint to the user via a display device coupled to a mobile device of the user, the graphical representation including visual indicators representing the first and second components at positions corresponding to the proper locations of the first and second components to be installed within the building; wherein the graphical representation of the digital blueprint displayed to the user includes a visual indication of the user's current position within the building; wherein the visual indication of the user's current position is based on a current geographic location of the user's mobile device within the building, wherein the current geographic location of the user's mobile device is based on location data derived from one or more sensors of the user's mobile device; wherein the input from the user includes a first identifier for the first component and a second identifier for the second component; wherein each of the first and second identifiers is an electronic serial number corresponding to each of the first and second components; wherein the electronic serial number for each of the first and second components is based on identifier information captured by the user's mobile device using one or more input devices coupled to the user's mobile device; and wherein the one or more input devices include a touchscreen display, an infrared (IR) scanner, a digital camera, an RFID tag reader, and an NFC tag reader.

In another embodiment, a non-transitory computer readable storage medium storing instructions that, when executed by a computer, cause the computer to perform functions to: obtain a parameter for a building in which an automation system is to be installed by a user within the building; receive input from the user for configuring a first component of the automation system and a second component of the automation system being installed, the input including a first location for installing the first component and a second location for installing the second component within the building; identify each of the first and second components of the automation system based on the input received from the user; obtain configuration information for properly configuring each of the identified first and second components of the automation system being installed in accordance with the obtained parameter for the building; determine whether or not each of the first and second components of the automation system being installed within the building is properly configured based on the obtained configuration information and the input received from the user indicating the first and second location of the respective first and second components; and provide the user with a notification indicating results of the determination for one or more of the first and second components, wherein the user is presented with options for modifying configuration settings for one or more of the first and second components.

It may be understood that both the foregoing general description and the following detailed description are exemplary and explanatory only, and are not restrictive of the disclosure, as claimed. The present invention will be more clearly understood from the detailed description below in conjunction with the accompanying drawings.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 schematically illustrates an exemplary building automation system, in accordance with an embodiment of the present disclosure.

FIG. 2 schematically illustrates an exemplary switch for a building automation system, in accordance with an embodiment of the present disclosure.

FIG. 3 schematically illustrates an exemplary outlet for a building automation system, in accordance with an embodiment of the present disclosure.

FIG. 4 depicts a flow diagram of an exemplary method for configuring a building automation system, in accordance with an embodiment of the present disclosure.

FIG. 5 depicts an exemplary Welcome Screen, which may be presented to a user via a graphical user interface (GUI) of a mobile application for configuring a building automation system, in accordance with an embodiment of the present disclosure.

FIG. 6 depicts an exemplary Blueprint Selection Screen for the GUI of the mobile application in FIG. 5, which may be used to select a blueprint indicating the respective locations of components of a building automation system, in accordance with an embodiment of the present disclosure.

FIG. 7 depicts an exemplary setup screen for the GUI of the mobile application for configuring a building automation system, in accordance with an embodiment of the present disclosure.

FIG. 8 depicts an exemplary selection screen for the GUI of the mobile application, which may be used to select configurable devices and display the status of each device during the configuration process for a building automation system, in accordance with an embodiment of the present disclosure.

FIG. 9 depicts an exemplary screen of the mobile application's GUI for highlighting a selected component to be configured for a building automation system, in accordance with an embodiment of the present disclosure.

FIG. 10 depicts another exemplary screen of the mobile application's GUI, which may be used to enter a serial number of an identified device to be configured for a building automation system, in accordance with an embodiment of the present disclosure.

FIG. 11 depicts yet another exemplary screen of the mobile application's GUI, which may be displayed when a building automation system is being configured, in accordance with an embodiment of the present disclosure.

FIG. 12 depicts yet another exemplary screen of the mobile application's GUI, which may provide status information related to devices of the building automation system during the installation process, in accordance with an embodiment of the present disclosure.

FIG. 13 depicts yet another exemplary screen of the mobile application's GUI, which provides a detailed view of components that may have issues to be resolved or otherwise require user input or action during the configuration/installation of a building automation system, in accordance with an embodiment of the present disclosure.

FIG. 14 depicts an exemplary system set up screen of the mobile application's GUI, which may be used to alter the preconfigured associations of components of the building automation system, in accordance with an embodiment of the present disclosure.

FIG. 15 depicts an exemplary screen of the mobile application's GUI, which indicates that a single component has been selected by the user for configuration of the building automation system, in accordance with a preferred embodiment of the present disclosure.

FIG. 16 depicts another exemplary screen of the mobile application's GUI, which may be presented to enable a user to change an association between different components of the building automation system, in accordance with an embodiment of the present disclosure.

FIG. 17 depicts a flowchart of an exemplary method for installing and configuring prepackaged component devices of a building automation system, in accordance with an embodiment of the present disclosure.

FIG. 18 depicts an exemplary setup screen of the mobile application's GUI, which indicates the locations of prepackaged components to be installed for a building automation system, in accordance with an embodiment of the present disclosure.

FIG. 19 depicts an exemplary screen of the mobile application's GUI, which may be used to enter address information during the setup of a building automation system, in accordance with an embodiment of the present disclosure.

FIG. 20 depicts an exemplary home screen of the mobile application's GUI, which may be displayed to a user for showing status information for a configured devices of a building automation system, in accordance with an embodiment of the present disclosure.

FIG. 21 depicts an exemplary informational view of the mobile application's GUI for presenting the user with information on the status of individual components, e.g., lights or lighting devices of a building automation system, in accordance with an embodiment of the present disclosure.

FIG. 22 depicts an exemplary configuration screen of the mobile application's GUI for configuring a single lighting device of the building automation system of FIG. 21, in accordance with an embodiment of the present disclosure.

### DETAILED DESCRIPTION

Reference now will be made in detail to embodiments of the present disclosure, examples of which are illustrated in the accompanying drawings. Wherever possible, the same reference numbers will be used throughout the drawings to refer to the same or like parts and/or components.

### Overview

An automation system, e.g., a home automation system, generally may include one or more switches and one or more outlets (or other suitable power delivery components), with the user desiring to control which outlet or outlets are controlled by each of the switch(es). Existing X10 devices require the user to manually set an address on the switch(es) and the outlet(s), wherein an outlet would respond to a switch with an identical address, e.g., the identically addressed switch may enable and/or disable power supplied by the outlet on command.

Embodiments of the present disclosure may include, among other things, an automation system. Examples of suitable systems include those described in U.S. application Ser. No. 13/672,534, filed Nov. 8, 2012, the entire disclosure of which is incorporated by reference herein. Systems according to the present disclosure may be used in, e.g., residential, commercial, and/or industrial structures. Non-limiting examples include single-family and multi-family dwellings, condominium units, apartments, apartment buildings, hospitals, nursing homes, prisons, cruise ships, offices, office buildings, schools, churches, sporting complexes, shopping centers, and manufacturing facilities.

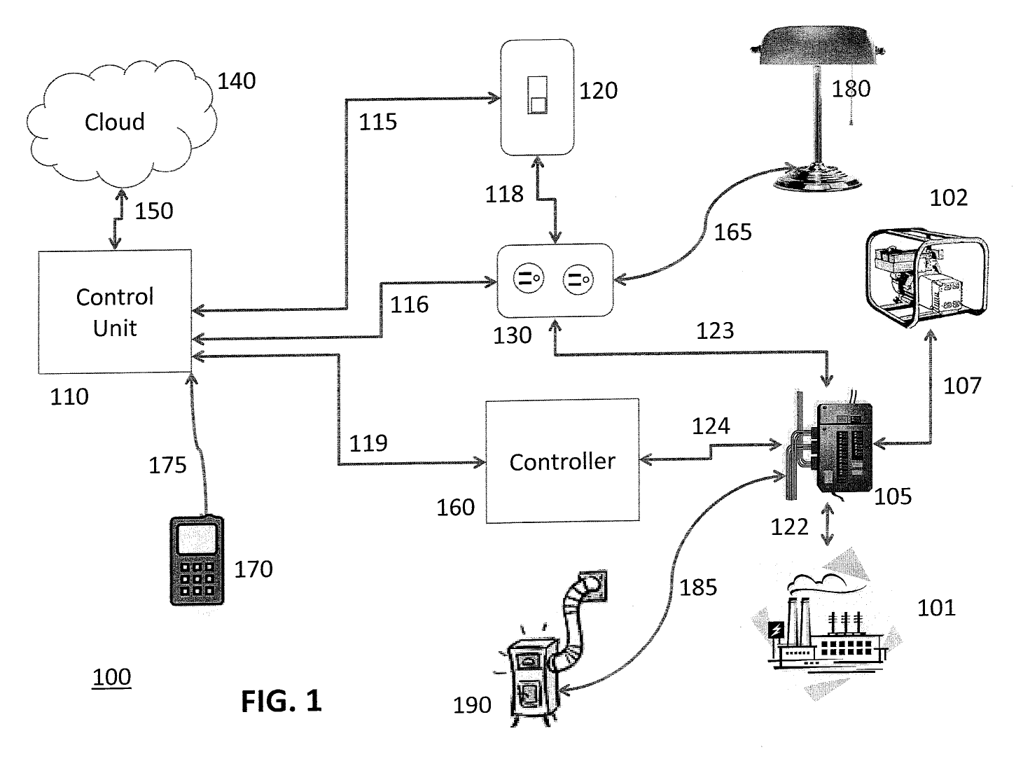

Embodiments of the present disclosure may be further understood with reference to FIGS. 1-22. In FIG. 1, for example, a building automation system 100 includes at least one outlet 130, which may be locally and/or remotely controlled. In some embodiments the outlet may be a junction box controlling appliances. The outlet 130 may be configured to monitor the power consumed by one or more devices (e.g., electrical appliances or components) connected thereto and/or to control power delivered by the outlet 130. The system 100 may further include a switch 120, which may send a signal (e.g., a wired or a wireless signal) to a control unit 110. The control unit 110 also may be locally or remotely controlled and may include, for example, a computer with a microprocessor, memory, and user interface. The control unit 110 may be a discrete control unit, e.g., a laptop, desktop, tablet, or any other suitable device. The control unit 110 may be connected via wired or wireless network connection 150 to the Internet or cloud 140, or any other electronic network. Cloud 140 may be any type of electronic network or combination of networks used for communicating digital content and data between various devices. Cloud 140 may include, for example, a local area network, a medium area network, or a wide area network, such as the Internet. The control unit 110 also may be connected to the switch 120 via a wired or wireless connection 115, and further connected to the outlet 130 via a wired or wireless connection 116. Similarly, the switch 120 may be connected to the outlet 130 via a wired or wireless connection 118.

The system 100 may include one or more other components or enhancements. Referring to FIG. 1, for example, the automation system 100 may include a controller 160 that can control (e.g., adjust, open, or close) physical structures, such as, e.g., window coverings. Controller 160 may be also configured to control other systems or enhancements associated with a home, office, school, or other structure discussed herein. For example, controller 160 may control systems for irrigation, heating, cooling, entertainment, and/or water heating. In addition, controller 160 may control one or more safety systems. In some embodiments, the controller 160 may receive instructions from the control unit 110 via wired or wireless connection 119. For example, the controller 160 may receive instructions from the control unit 110 for controlling window treatments.

The switch 120 may also communicate with the controller 160, outlet 130, and/or one or more other components of system 100 via wired or wireless means (not shown). The wired or wireless connections, for example, connections 115, 116, 118, and 119, may use the same or different protocols or standards. In some embodiments, switch 120 may communicate with outlet 130 through one or more devices of the system 100. For example, switch 120 may communicate with a second outlet (not shown) or other component of the system 100 through control unit 110, e.g., switch 120 may send a signal to control unit 110, and control unit 110 may send a signal to the second outlet. In some embodiments, switch 120 may send a signal to outlet 130, which may send a signal to the second outlet, thereby permitting communication between switch 120 and the second outlet. Other components of system 100 may similarly relay and/or send messages on behalf of one component, e.g., a first component, to another component, e.g., a second component. This may be beneficial (in some cases required), such as if a direct communication path between the first and second components does not exist.

In some embodiments, the automation system 100 may include securing mechanisms such as, e.g., closure fasteners, including locks, which may be locks on doors, windows, pet doors, garages, sheds, outdoor storage bins, cabinets, or other locking or catching devices that may be installed and selectively actuated. Such devices also may be on a lock box or other item that can be moved or transported. A switch, such as switch 120, may be paired with a lock device or other closure fastener, such that operating the switch causes the lock to lock (or engage) or unlock (or disengage). Those of ordinary skill in the art will understand that the principles described herein may be applied to devices for maintaining a position of a blocking member, such as, e.g., a door. For example, such a switch may be paired with a holding device for maintaining a door in an open position or an intermediate position, which may be between a completely open position and a completely closed position.

In addition to instructions being processed by control unit 110, some or all of the processing could be performed by one or more microprocessors included in the switch 120, the Internet or cloud 140, or the outlet 130. It is understood that the system 100 may include multiple switches 120, outlets 130, and/or controllers 160, e.g., window control units. Other devices, such as sensors, may be in communication with the system 100 to provide information, including, e.g., temperature, light intensity, etc. In some embodiments, for example, the system may include or otherwise be in communication with a moisture sensor for providing information on the presence of water, e.g., humidity, rain, snow, or other precipitation. Each outlet 130, switch 120, control unit 110, and controller 160 may include one or more features of the outlet, switch, control, and controller, respectively, described in U.S. application Ser. No. 13/672,534, filed Nov. 8, 2012, which is incorporated herein by reference in its entirety.

A mobile device 170 may be wirelessly connected to the system 100 via wireless connection 175. For example, the mobile device 170 may be connected to the control unit 110 as shown in FIG. 1 via wireless connection, and/or may be connected to the outlet 130, controller 160, switch 120, another device in communication with the automation system 100, or any combinations thereof. The mobile device 170 may include a wireless transceiver, which provides means to measure received signal strength. The mobile device 170 may include any suitable means of collecting, recording, analyzing, and/or transmitting data in order to locate, characterize, and/or otherwise identify one or more devices or components of the automation system 100. In some embodiments, for example, the mobile device 170 may include a heat sensor and/or an RF sensor. Further, in some embodiments, the mobile device 170 may include an imaging device, e.g., a camera, for taking and transmitting pictures or other suitable images. The mobile device 170 may include means for determining location and/or orientation information. Non-limiting examples of such technology includes a global positioning system (GPS), accelerometers, compasses, and gyroscopes. The mobile device 170 may collect data to determine the orientation of the camera when taking a picture, e.g., whether the camera is pointed towards a ceiling, a floor, or a wall. The geographic location and cardinal direction of the camera may also be determined via a compass, GPS, accelerometer, and/or other suitable data collected by the mobile device 170 or one or more sensors coupled thereto. In addition to instructions being processed by control unit 110, some or all of the processing could be performed by mobile device 170. Suitable methods of collecting and processing such information are described in U.S. application Ser. No. 13/766,123, filed Feb. 13, 2013, which is incorporated herein by reference in its entirety. In at least one embodiment, mobile device 170 may include a smartphone, which may have a touchscreen. In a further embodiment, the mobile device 170 may be one or more smart phones, tablets, or other computer device utilized by, for example, a contractor during installation of the automation system 100, e.g., during construction of the building.

Further referring to FIG. 1, electrical energy or power may be generated at power plant 101, and transmitted to a meter device or breaker box 105 via, for example, wired transmission lines 122. The methods presently disclosed also may be applied to other utilities and/or alternative energy sources, such as, e.g., water, natural gas, steam, heat, solar, wind, geothermal, algal, biomass, or any other utility or resource. Further, the term “utilities,” as used herein, is contemplated to include other services including, but not limited to, internet connections, data, voice, telecommunications, and/or broadcast services. Power may be routed to the outlet 130 by wires 123, and routed to controller 160 via wires 124. Power may be further routed to a heating ventilation and air conditioning (HVAC) system 190 via wire 185. It is also expected that power could be transmitted wirelessly and one or more of wires 122, 123, 124, and/or 185 could be replaced with wireless transmission methods. Each set of transmission wires, such as wires 123, may be referred to as a circuit. A circuit may, for example, be connected to and provide power to multiple devices, e.g., via multiple outlets 130. In some embodiments of the present disclosure, the system includes one or more circuits, e.g., circuit 123.

Breaker box 105 may measure voltage, current, and/or power on one or more power lines leading into and out of the breaker box 105. Breaker box 105 may, for example, include a utility meter. Breaker box 105 may be connected (e.g., wired or wirelessly) to automation system 100, and may include one or more sensors, such as voltage meters, current meters, temperature sensors, or other types of sensors. The sensor(s) may be connected (e.g., wired or wirelessly) to the automation system 100.

An appliance 180, e.g., a desk lamp, may be plugged into or otherwise operably coupled to an outlet 130 or other suitable power delivery component through connection 165, which may be wired or wireless. The appliance 180 may be able to communicate with system 100 and/or another entity or component of automation system 100 or coupled to automation system 100, and the appliance 180 may have the ability to measure the amount of power drawn from outlet 130.

Generator 102 also may be connected to breaker box 105 via wired connection 107. Generator 102 may be, for example, a backup generator, such as a natural gas or gasoline generator. Generator 102 may also use a flywheel, solar array, battery, or other method of storing or generating power. Generator 102 may be configured to start operating if, for example, the supply of power from power plant 101 is interrupted or is otherwise unable to supply sufficient power to one or more connected devices. In some implementations, upon detecting an interruption in the power supply, breaker box 105 may function to break the connection between transmission lines 122 and the connected devices through wires such as 123 and 124, and instead, connect these devices to generator 102 through wires such as 123 and 124.

Breaker box 105 may inform system 100 which power supply, e.g., generator 102 or power plant 101, is providing power to system 100. If generator 102 is determined to have relatively less capacity for providing power than power plant 101, then system 100 may be configured to reduce the number of devices that are drawing power so as to ensure that the capacity of either power supply is not exceeded. In an example, devices such as refrigerators or freezers are typically powered with a backup generator during a power outage so that food contained within these appliances does not spoil. Thus, system 100 may allow power to flow to a refrigerator or freezer by enabling power delivery to those outlets that such appliances are plugged into. Other devices such as the appliance 180 (e.g., desk lamp or other lighting device) may be prevented from drawing power by turning off the outlet (e.g., outlet 130), to which the appliance 180 is connected or plugged-in.

System 100 may be configured to enable HVAC system 190 and disable other devices, such as a refrigerator or freezer, while the HVAC system 190 is drawing power. In some embodiments, system 100 may be configured to monitor a device (e.g. an outlet, appliance or an electrical device) to ensure it is operating within, for example, a predetermined set of operating parameters or within a desired operational or functional threshold. In some instances, “parameter” could be based on building specifications, locations or layouts, or a building construction blueprint. Device operational and functional parameters as well as building and construction parameters used by an automation system such as system 100 in accordance with this disclosure is collectively referred to as “parameters” hereinafter. For example, system 100 may monitor the refrigerator or freezer to make sure the temperature inside the appliance does not exceed a predetermined threshold value. Typically, appliances such as refrigerators and freezers have thermal momentum, which allows the temperature inside such appliances to warm at relatively slow pace once the power supplies to these devices are turned off. Therefore, system 100 can be configured to monitor the internal temperatures of such appliances and allow other devices connected to system 100 to operate while the refrigerator and freezer slowly warm up but remain below a threshold temperature. The threshold temperature may be chosen such that the contents of the appliance are maintained at a desired temperature.

In some embodiments, the temperature outside the refrigerator or freezer may be monitored via, e.g., any suitable means. The refrigerator or freezer can be expected to warm up at a rate related to the temperature difference outside to inside the device, time, and the insulation of the device. The automation system 100 may measure the temperature inside the refrigerator, measure the temperature outside the refrigerator, turn the refrigerator off for a period of time such as 15 minutes, and then turn the refrigerator back on and measure any change in the internal temperature. If the temperature has not changed, the test may be repeated with a longer time such as 30 minutes or 1 hour, or longer. By measuring the temperature change the thermal constant of the refrigerator can be calculated. This would allow the automation system 100 to determine how long the refrigerator can be turned off without the refrigerator temperature rising above a threshold temperature determined safe for the contents. The thermal constant for the freezer and refrigerator sections may be separately measured and determined.

It is known that a refrigerator or freezer will warm more slowly if it is full of food or other material. The material stored has thermal resistance that will help hold a temperature if power is turned off to the refrigeration unit. The automation system may further track how much material is in the unit and use that information to help determine how long a refrigerator can be unpowered and stay below a threshold temperature. Material within a refrigerator unit may be tracked by any suitable means. For example, each surface or shelf may be configured as weight sensing surface that is capable of detecting the presence of a load-bearing object placed thereon.

The methods of keeping a refrigerator below a threshold temperature can be applied to an oven to keep an internal oven temperature above a threshold.

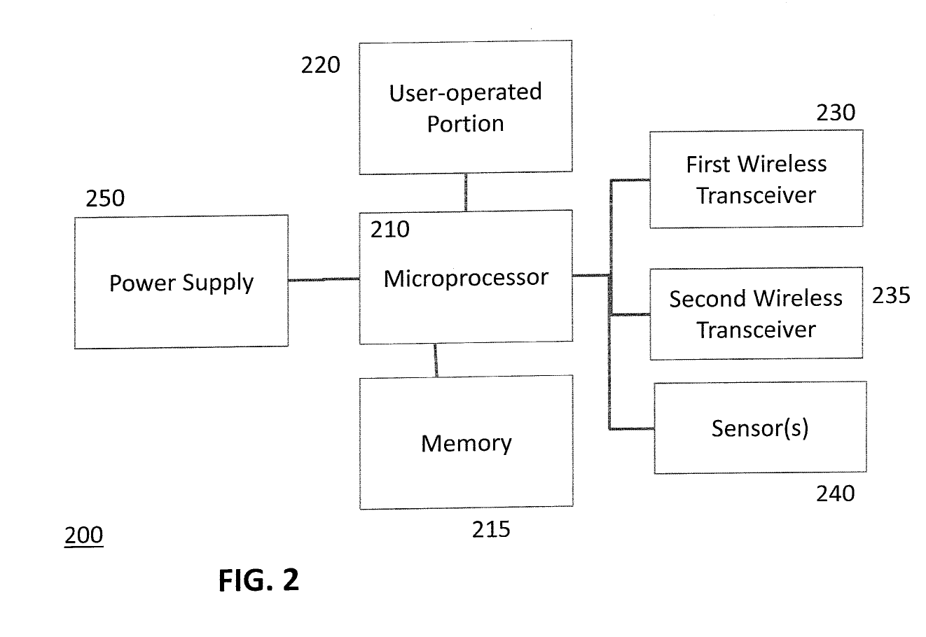

FIG. 2 shows a block diagram for a switch 200 that may be used in the automation system 100 and may operate as the switch 120 in FIG. 1. Switch 200 may be any suitable actuator known in the art. In at least some embodiments, the switch 200 may be remotely controlled. The switch 200 may include a microprocessor 210 capable of running software or an algorithm stored in memory 215. Memory 215 may be, e.g., solid state or flash memory, or any other suitable type of memory. The switch 200 may include a user-operated portion 220, such as a mechanical lever. In some embodiments, the switch 200 includes one or more user input devices, including, for example, a touch sensor, a touch screen, and/or push buttons. User-operated portion 220 may be configured to control (e.g., interrupt, adjust, change, terminate, and/or meter) the supply of energy to or from a device or an outlet (e.g., outlet 130 shown in FIG. 1) in communication with switch 200. In at least some embodiments, the user-operated portion 220 is configured to control the supply of electrical energy to a device or outlet 130. Accordingly, in one embodiment, the user-operated portion 220 may be configured to transition between an “on” position and an “off” position (i.e., supplying and terminating power, respectively). In another embodiment, the switch 200 may allow various levels to be controlled by the user discretely or continuously (e.g., increasing or decreasing power supply). That is, user-operated portion 220 may be configured to provide a dimming function or otherwise vary at least one of the voltage and the current of the electrical power supplied to outlet 130.

The switch 200 may further include a first wireless transceiver 230, for example, an 802.11 Wi-Fi transceiver. The term “transceiver” as used herein should not be construed as limited to any particular structural components. Instead, a transceiver may include any structural components configured to allow for back and forth communication, e.g., communication exchange. Accordingly, the transceivers disclosed herein may include, but are not limited to, antennae, power supplies, communication ports, and/or any other elements needed to achieve the desired function. The first wireless transceiver 230 may be configured to communicate over any known protocol including, but not limited to, X10, Zigbee®, and/or Bluetooth. Further, although the exemplary embodiment of FIG. 2 depicts the transceiver 230 as a wireless transceiver, those of ordinary skill will readily recognize that first wireless transceiver 230 may be replaced with a wired communication mode. First wireless transceiver 230 may allow the switch 200 to communicate with a control device, e.g., the control unit 110 as shown in FIG. 1. The first wireless transceiver 230 therefore may allow the switch 200 to exchange one or more commands with the control unit 110 of the automation system 100.

In some embodiments, the switch 200 may also include a second wireless transceiver 235 to allow the switch 200 to communicate with one or more devices (e.g., the outlet 130 shown in FIG. 1 and/or any electrical load coupled thereto) using multiple standards. Both transceivers 230 and 235 may include received signal-strength indicator means to identify the strength of a signal received by the transceiver. The first and second wireless transceivers 230, 235, respectively, may allow for communication over one or more protocols, including, but not limited to, the aforementioned protocols. In addition, the first wireless transceiver 230 may be configured to communicate over a protocol that is different from the communication protocol of the second wireless transceiver 235.

The switch 200 may include one or more sensors 240 configured to detect and/or respond to various conditions or stimuli, such as temperature, moisture (e.g., water, rain, or humidity), light, sound, air flow, contaminants, motion, and/or electromagnetic or radio frequencies. Examples of such sensors 240 are disclosed in U.S. application Ser. No. 13/672,534, filed on Nov. 8, 2012, which is incorporated herein by reference. The sensor(s) may include a camera, imager, and/or IR sensor. The sensor(s) may be used to detect and/or identify persons, animals, and/or objects in the vicinity of the switch 200 and may be used to determine the identity of a person actuating a switch 200. Data from the sensor(s) 240 may be processed in the switch 200 and/or via another device coupled to system 100. The processing may include comparing the sensor data to sensor data stored locally or remotely in a database to determine an identity, such as the identity of the most likely person to be in the vicinity of the switch 200, or the most likely person to actuate the switch 200. The sensor may include an algorithm or other software to identify a person, e.g., via physical characteristics, such as facial recognition or fingerprint, or auditory characteristics, such as voice recognition, or may communicate with one or more other components of system 100 to identify a person through physical and/or auditory characteristics detected by the sensor.

The sensor data may be sampled at a periodic or aperiodic rate, which may increase in response to stimuli (e.g., if one or more persons are in the vicinity of the switch 200) and decrease in the absence of stimuli (e.g., when persons are not in the vicinity of the switch 200). The sensor may sample, e.g., collect, store, and/or display, data upon actuation of the switch 200.

One or more transceivers (e.g., first wireless transceiver 230 and/or second wireless transceiver 235) may communicate with a device associated with (e.g., carried by) a person, such as a mobile device 170, e.g., a smartphone. By communicating with mobile device 170 and/or by monitoring a signal emitted from mobile device 170, switch 200 may determine that mobile device 170 is near the switch 200. This may be determined by any suitable means, such as, e.g., by measuring the strength of the signal emitted by mobile device 170, by measuring the time delay of a message to or from mobile device 170, or by other means known in the art. One or more components of system 100 may recognize an association between mobile device 170 and one or more persons, for example, and thereby system 100 may associate mobile device 170 with a particular person or operator. If switch 200 detects that mobile device 170 is in the vicinity of the switch 200, then system 100 may determine or otherwise understand that the owner or operator of mobile device 170 is also in the vicinity of switch 200.

The switch 200 may include a power supply 250, which may be any suitable power supply known in the art. In some embodiments, for example, the power supply 250 includes a battery, e.g., a rechargeable battery. It is understood that the power supply 250 in FIG. 2 may schematically illustrate a wired or wireless connection to a power network, such as, e.g., a power grid or transformer. Further, the power supply 250 may include both a battery and a connection to a power network. The sensor may allow at least one of the voltage and current to be measured at connection 350. The switch may include solar cells. In some embodiments, the switch may include circuitry to harvest energy such as energy from WIFI or other RF or radiated energy that may be accumulated by the switch 200 to operate the switch.

The switch 200 may include a microprocessor 210, which may be any suitable microprocessor known in the art. Although FIG. 2 shows the microprocessor 210 located within the switch 200, in some embodiments the microprocessor 210 may be remotely connected to the switch 200. The microprocessor 210 may be configured to communicate, e.g., exchange control signals, with the one or more sensors 240, the first wireless transceiver 230, the second wireless transceiver 235, and/or the user-operated portion 220 of switch 200.

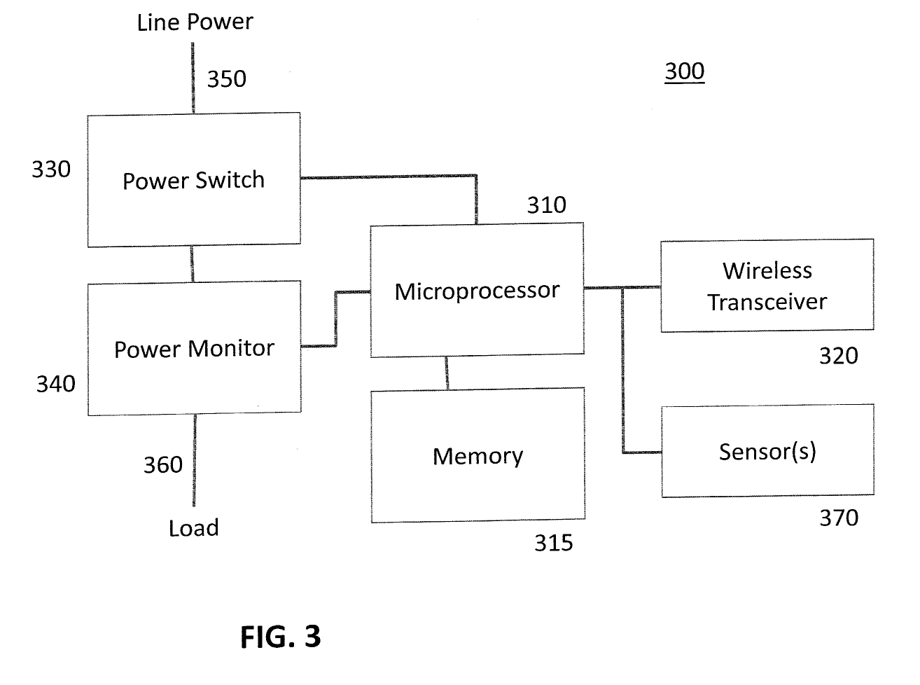

FIG. 3 shows a block diagram of an outlet 300 that may operate as the outlet 130 of the system 100 shown in FIG. 1. In at least some embodiments, the outlet 300 is remotely controlled. The outlet 300 may include a microprocessor 310 that runs software or an algorithm stored in memory 315. The microprocessor may be remotely connected to outlet 200. The outlet 300 further may include a transceiver 320, which may include any of the features described in connection with transceivers 230 and 235 of FIG. 2. The outlet 300 also may include one or more sensors 370, which can include, e.g., motion sensors, voltage sensors, current meters, ambient light sensors, cameras, microphones, moisture sensors, or any of the sensors described above with respect to the one or more sensors 240 of FIG. 2. The sensors may allow at least one of the voltage and current to be measured at connection 350 with a source of electrical energy.

In some embodiments, the outlet 300 receives electrical energy via a power switch 330 supplied by line power via connection 350. The power switch 330 may be controlled by a microprocessor, e.g., microprocessor 310, which may include any of the features described with respect to the microprocessor 210 of FIG. 2. The power switch 330, as illustrated in FIG. 3, may be configured to connect and/or disconnect the line power to the outlet 300, including a connected load 360 (e.g., one or more electrical devices coupled to the outlet 300). The power switch 330 also may be configured to vary (e.g., increase, reduce, or otherwise control) a voltage or current delivered to the load 360, thus providing a dimming function.

The outlet 300 may further include a power monitor 340 for measuring the consumption of power by the load 360 connected to the outlet 300. The power monitor 340 may measure voltage and/or may measure current of the electrical energy delivered to the load 360, and this may include for example, measuring average values, RMS values, or sampling the waveform of the measured characteristic. The load 360 may be connected via any suitable means, such as, e.g., standard 2 or 3 pin power outlets, 220V outlets, or international standard outlets, and may also include a wireless connection such as via a wireless charger. The power meter/monitor 340 may transmit measured power data to the microprocessor 310 via the transceiver 320, or may also transmit data to one or more other components or devices of the system 100.

In some embodiments, the power monitor 340 measures noise in the connection to the load 360 in order to determine the type of energy-consuming device(s) connected to outlet 300. See, e.g., U.S. application Ser. No. 13/672,534, which is incorporated herein by reference. This type of analysis is discussed, for example, in U.S. Pat. No. 8,094,034. Multiple connections throughout an entire structure may be monitored and analyzed to determine the types of devices, such as appliances, connected to define the load 360, e.g., by turning the devices on and off. In some embodiments, user activity may be inferred by monitoring a structure, e.g., identifying which loads are activated and deactivated. By monitoring power consumption characteristics of the load 360, one or more characteristics of a device connected to the outlet 300 may be determined, e.g., via techniques disclosed in U.S. Pat. No. 8,094,034 or other suitable analytical methods. Based on the power consumption characteristic(s), the device (e.g., an oven, refrigerator, fan, or other appliance) may be beneficially and intelligently identified and controlled.

In some embodiments, the outlet 300 may be connected to an appliance at 360 (i.e., an appliance as the load 360). The appliance may have a power switch similar to power switch 330 of the outlet 300 to turn the appliance on or off and/or to place the appliance in an intermediate state, such as dimming, standby, or another state of reduced energy consumption. The appliance power switch 330 may control power to the appliance, e.g., supply and/or terminate or disable power to the appliance. In one embodiment the power switch 330 may be composed of a relay and a TRIAC (Triode for Alternating Current) configured generally in parallel. The TRIAC may be used to provide a dimming function, by reducing the power provided to an appliance. The relay may also be used to provide power to an appliance or device connected to 360.

In some embodiments, the outlet 300 may monitor the state of the appliance to determine if the appliance power switch has been actuated. One method of determining actuation of the appliance power switch is to measure the resistance of the appliance, i.e., the resistance of the load 360 connected to the outlet 300. For example, a relatively small amount of electrical current or voltage may be supplied to the appliance, and resistance may be measured, e.g., with an ohmmeter or other suitable device. If the appliance power switch is set to turn the appliance on, the appliance may present a relatively low impedance to the supplied current/voltage, whereas if the power switch is set to turn the appliance off, the appliance may present a relatively high impedance. By measuring the impedance of the load 360, the outlet 300 may determine the state of the appliance power switch and determine if the state of the switch has changed.

The outlet 300 may have electrical and/or mechanical capability of determining whether a plug is connected to a socket of the outlet 300. For example, the outlet 300 may include an electrical sensor and/or mechanical mechanism for detecting a connection or otherwise detecting the presence of a plug within or otherwise coupled to outlet 300. Such sensors may include, but are not limited to, proximity sensors, mechanical switches, imagers, cameras, etc. Further, the outlet 300 may include an RF sensor for detecting an RF signal emitted by a plug, e.g., if the plug is sufficiently close to the outlet 300. Other suitable means of detecting and/or identifying whether an appliance or other device is connected to the outlet 300 will be known to those of ordinary skill in the art.

If the outlet 300 recognizes or detects a connection, e.g., determines that a plug is connected to the socket of outlet 300 or detects a wireless connection to an appliance, the outlet 300 may monitor the state or condition of the appliance, e.g., whether the appliance is turned on or turned off. In some embodiments, for example, the outlet 300 may monitor the appliance continuously for a change in state.

In some embodiments, the outlet 300 may monitor whether an appliance operably coupled to outlet 300 is turned on, turned off, or placed in an intermediate state when a person is determined to be in the vicinity of the appliance. For example, the outlet 300 may include a sensor 370 that may determine that a person is in a given area or radius of the appliance. Alternatively, or in addition, a sensor otherwise connected to the automation system 100 such as sensor 240 may determine that a person is in the area of the appliance. For example, a person may be in the same room as the appliance, in the same house or structure as the appliance, or within a certain predetermined distance of the appliance, such as, for example, from about 1-10 feet, e.g., within about 3 feet or 5 feet. The presence of a person may be determined by any suitable method, including, but not limited to, a motion sensor, a camera, or the presence of a mobile device, e.g., mobile device 170. In some embodiments, for example, the automation system 100 may determine the presence or identity of a person by determining the location of a mobile device 170. In other embodiments, the automation system 100 may detect the presence of a person by detecting one or more other components of the system 100 being turned on, turned off, or otherwise adjusted in a given area. For example, the system 100 may detect a light being turned on and determine that a person is near the light. If no one is detected within the vicinity of the appliance, the outlet 300 may not conduct any monitoring, or may monitor the appliance periodically.

In some embodiments, system 100 may send instructions to one or more components of system 100 to detect and/or identify a person. For example, if a switch 200 is known to be near outlet 300 and/or another device of system 100, and if any of the devices detect the presence of a person, the system 100 may send instructions via switch 200 to one or more devices in the vicinity, e.g., all devices in the vicinity of the person may attempt to detect and identify the person. In some embodiments, system 100 may send instructions directly to one or more devices in the vicinity of the person to detect and identify the person.

In some embodiments, for example, the outlet 300 may periodically check if a power switch on the appliance has been actuated. For example, the outlet 300 may monitor the appliance every 5 minutes, 10 minutes, 15 minutes, 30 minutes, 1 hour, 2 hours, 6 hours, 12 hours, 24 hours, or at any suitable interval, for a change in state. The periodicity may be adjusted depending on the time of day, the presence of a person, motions or other activity of a person, and/or other inputs to the automation system 100. For example, an outlet 300 may have an appliance plugged in, wherein initially power is not supplied to the appliance. When the appliance is switched on, the outlet 300 may monitor the state of the appliance continuously, or the outlet 300 may monitor the state of the appliance periodically, such as every 5 minutes. If a person is determined to be in the vicinity of the appliance and not moving, the outlet 300 may, for example, monitor the appliance every 5, 10, 15, 20, 25, 30, 45, or 60 seconds. If the person in the vicinity of the appliance is moving, however, the outlet 300 may monitor the appliance more frequently, such as every 1 second.

If the outlet 300 does not determine that an appliance or other device is connected, e.g., plugged into the socket or otherwise connected wirelessly, the outlet 300 may not conduct any monitoring. The outlet 300 may periodically check to determine whether an appliance is connected, e.g., electrically and/or mechanically, as discussed above.

The outlet 300 may comprise a device that is included in a junction box or coupled to an electrical system, e.g., to provide power to another utility or device. By way of example, this could be a device included in a ceiling junction box that is coupled (e.g., wired) to, e.g., a ceiling fan, a device included inline to power outside flood lights, a device that monitors and/or controls the flow of natural gas to a furnace, among other variations.

In further embodiments, outlet 300 may be configured to selectively control the electrical energy delivered to a load 360 coupled thereto. That is, outlet 300 may be configured to vary the current or voltage delivered to a load 360. In order to perform such variations, or provide a dimming function, outlet 300 may include one or more TRIACS and relays in a circuit, e.g., parallel. As those of ordinary skill in the art will understand, the TRIAC may be provided to facilitate the dimming function, by, e.g., varying voltage, while the relay may facilitate routine on/off functionality.

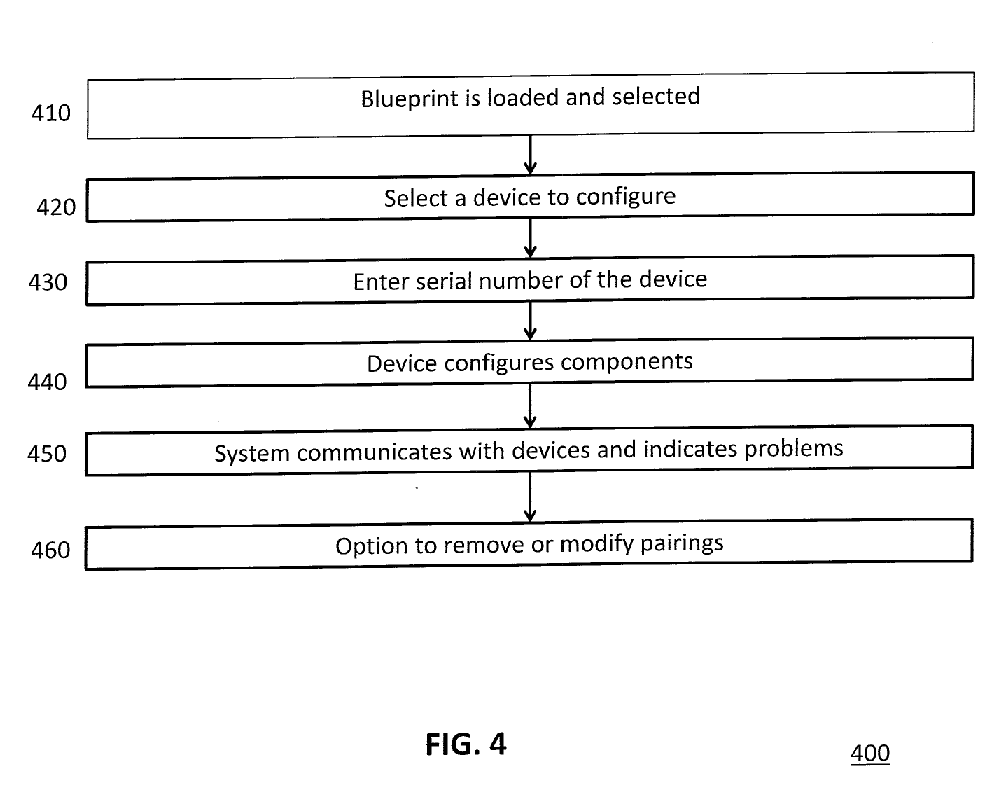

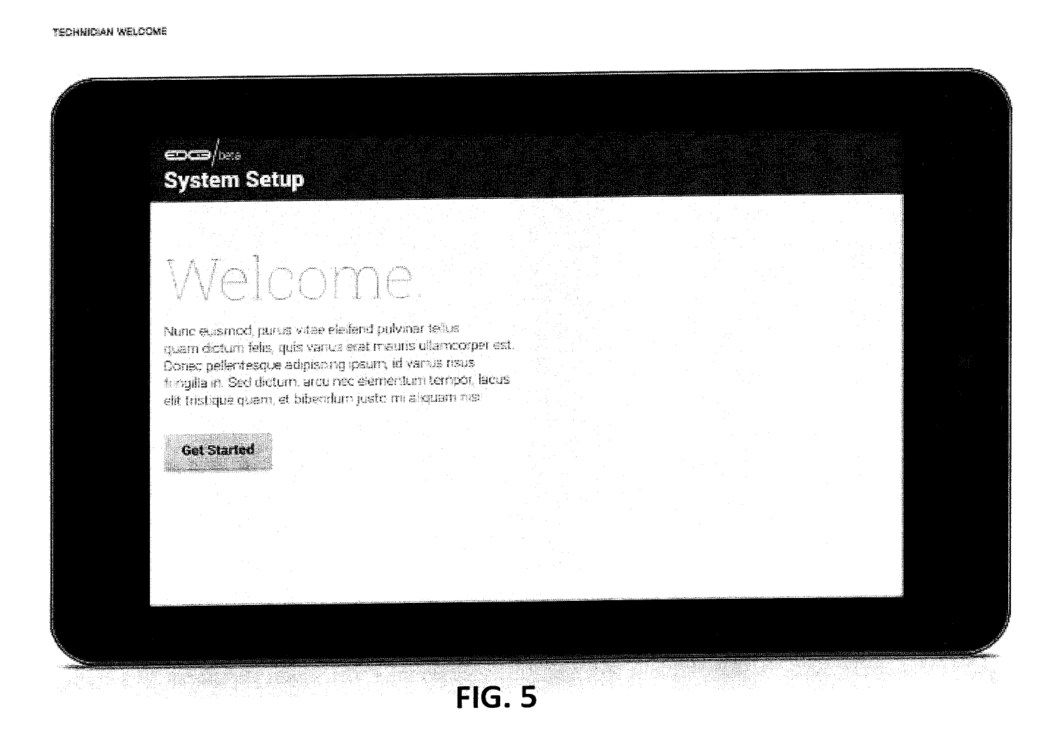

Turning now to FIG. 4, a flowchart is shown to depict an exemplary method 400 of setting up an automation system, e.g., automation system 100 of FIG. 1, as described above, for a commercial or residential building. While method 400 will be described using automation system 100 of FIG. 1, it should be noted that this is for discussion purposes only and that method 400 is not intended to be limited thereto. Further, for purposes of discussion, method 400 will be described using exemplary user interface screens, as illustrated in FIGS. 5-16, which may be displayed to a user via a GUI of a mobile application executable at the user's mobile device for configuring a building automation system. However, it should be noted that method 400 is not intended to be limited thereto and that the techniques disclosed herein may be applied to desktop computers or other types of personal computing devices, as will be described in further detail below.

In some embodiments, the automation system may determine that at least part of the location is considered residential, and/or part of the location is considered commercial or otherwise non-residential. The determination may be provided by the blueprints, which may be loaded as described below. The determination may be provided by the installer or another authorized person. The determination may be made by a component of the automation system such as controller 110, based on rules stored in software on the device or rules stored on a server in the internet accessible by the device. The automation system may provide feedback on rules and regulations applicable to the elements of the automation system that are dependent on a commercial or residential designation. For example: commercial locations may permit overhead lighting to be centrally controlled without a switch, but overhead lighting in residential space may require a paired switch. Residential or commercial designated space may require different ratings on outlets (such as 20 A versus 15 A), wiring, spacing, etc., which may be communicated by an element of the automation system 100 to the installer or home owner during installation or later during expansion of the system.

Method 400 begins in step 410, in which an electronic blueprint may be loaded into a user's computing device or a control unit 110. In an example, the user may be an installation service provider for the automation system, and the user's computing device may be, for example, a mobile computing device (e.g., mobile device 170 of FIG. 1, as described above) including a mobile application for configuring components or devices of a building automation system during the installation of these devices at a various locations throughout the building. However, it should be noted that the user's device may be any type of computing device having at least one processor (e.g., microprocessor 310 of FIG. 3, as described above) and a memory for storing instructions (e.g., software instructions for a mobile application) that are readable by the processor and that cause the processor to perform various functions associated with configuring the automation system, as will be described in further detail below. For example, the device may be a desktop computer or other personal computing device. In some implementations, the personal computing device may be a wearable device. Such a wearable device may be, for example and without limitation, a wearable headset device (e.g., computerized eyewear or glasses) or any other type of portable computing device, or distributed computing device that may be wearable by a user, e.g., attachable to a piece of clothing or body part of the user. Further, the device may be contained in a single housing or may be distributed across multiple housings that may be communicatively coupled to each other (e.g., via a wired or wireless connection).

The electronic blueprint that may be loaded onto the user's device in the above example may be an electronic rendition or digital representation of an architectural or construction blueprint for a building. The digital representation may be based on, for example, a digital image or scan of a blueprint, e.g., as captured by a digital camera coupled to or integrated with the user's computing device. Portions of such a digital blueprint also may be based on, for example, information related to the various components of the automation system (e.g., automation system 100 of FIG. 1, as described above) to be installed and configured by the user. Examples of such information include, but are not limited to, device identification information, configuration settings, and selected locations within the particular building at which each device is to be installed. Such information may be stored within, for example, an electronic database communicatively coupled to the user's device via an electronic communication network (e.g., via cloud 140 of FIG. 1). The above-described electronic blueprint and component data for the automation system may be loaded to the user's device over the Internet via Wi-Fi, cellular, or other wireless connection (e.g., Bluetooth), or via a wired connection. Further, the blueprint may be transferred to the user's device from an SD (secure data) card, universal serial bus (USB) memory stick, radio-frequency identification (RFID) tag, or similar type of external memory device that may be coupled to the user's computing device for transferring electronic data. The blueprint may be loaded directly onto the device by, for example, taking a picture of a blueprint, or otherwise scanning a drawing that contains blueprint information. The data on the device may be the blueprint data or may be a link or pointer to the blueprint data stored in a remote data store or memory location that is accessible to the user's device via a network, as described above. The blueprint data may include, for example and without limitation, data about the location of automation system devices to be installed within the building, data about the type of devices to be installed, and may include information specifying which of these devices should be associated together during the installation. The association data may include, for example, default configuration settings for the automation devices to be installed at particular locations within the building. It should also be noted that the blueprint data may include information pertaining to any other data that may be found in a construction blueprint for a building.

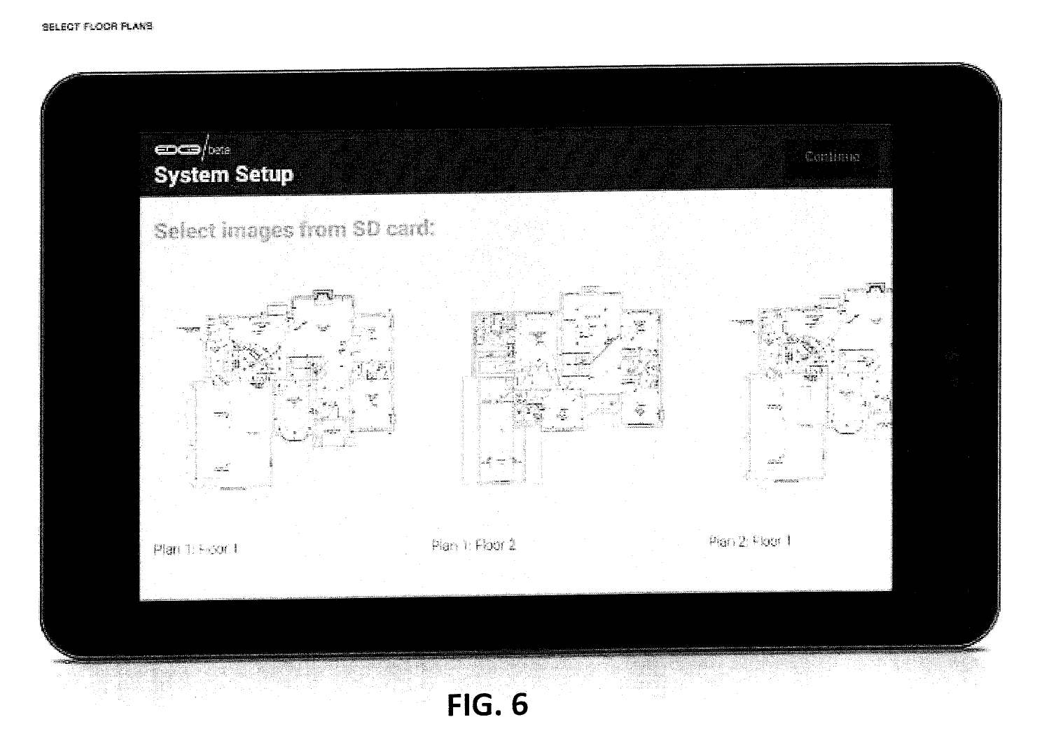

Prior to, during, or after loading the blueprint, a user installing an automation system for a building (also referred to herein as “an installer”) may be presented with a welcome screen, such as the exemplary Welcome Screen for a GUI of a mobile application executable at the user's mobile device, as illustrated in FIG. 5. As shown in FIG. 6, the user may be presented with a set of blueprints, from which a particular blueprint may be selected as desired by the user. In some implementations, the user's device or application executable at the device may be configured to automatically identify the user as, for example, an electrician or a plumber, and thus, may preferentially display the electrical or plumbing information, respectively, associated with the blueprints. The device may determine the identity of the user based on, for example, login information supplied by the user via a sign-in or login page displayed to the user at the device. Alternatively, the device or application executable at the device may determine the user's identity based on an RFID or near field communication (NFC) tag physically held by or coupled to the user, when the user is in close proximity to (e.g., within a predetermined radius of) the device. In yet another example, the user's identity may be derived from a default setting stored at the device. In some implementations, the stored default setting information may include biometric data (e.g., a digital model or exemplar of the user's fingerprint), which can be compared to user input data captured by a biometric sensor (e.g., fingerprint sensor) coupled to or integrated with the user's device. The user is free to choose and display other views of the blueprints, but the device may anticipate and preferentially display the blueprints the user is most likely to need. The device may also have the capability of determining the user's physical location within the building, e.g., based on data from a GPS, altimeter, association with an access point or cellular tower, user input, or other type of sensor or location-determining means available to the user's device, and then displaying, e.g., via a touchscreen display of the device, a portion of the blueprint that corresponds to the user's location

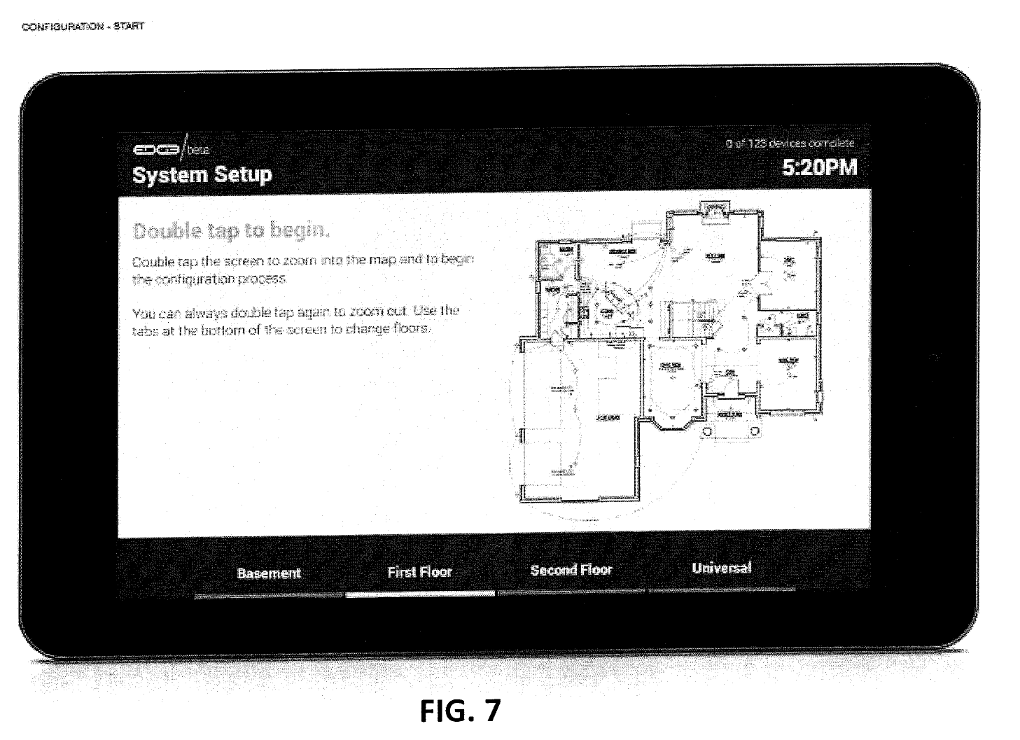

FIG. 7 depicts an exemplary setup screen for the GUI of the mobile application for configuring a building automation system, in accordance with an embodiment of the present disclosure. As shown in FIG. 7, the setup screen displayed to the user may include soft selection buttons along a portion (e.g., at the bottom) of the screen, which may correspond to different floors of the building, e.g., basement, first floor (e.g., as currently selected in FIG. 7), second floor, etc., and may allow the user to choose a blueprint corresponding to a selected floor to be displayed at the user's device. The floor listing may be on a ribbon to allow the user to select from a long list of floors, as may be needed in, for example, a high rise office, hotel, or condominium building.

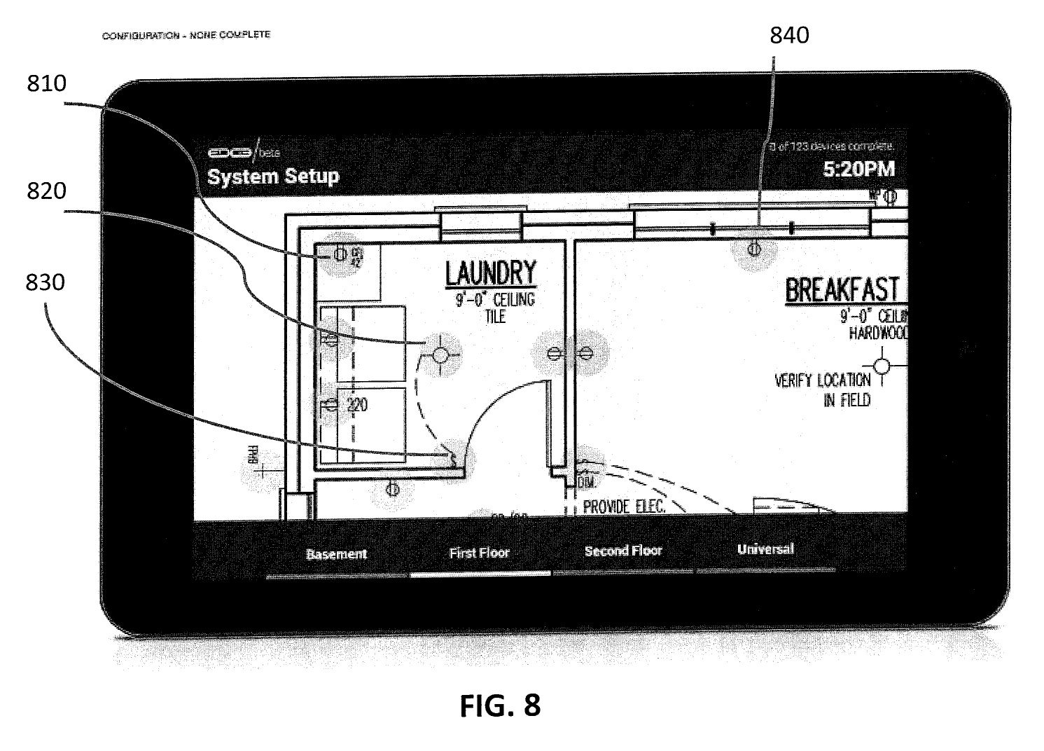

Referring back to FIG. 4, in step 420 of method 400, the user may select a particular component or device of the automation system to configure. FIG. 8 illustrates an exemplary view of a selection screen for displaying devices that may be selected by the user, e.g., via the GUI of the mobile application executable at the user's device. A symbol 810 may be used to indicate the location of outlets on the displayed blueprint. Each outlet may include, for example, a single, a double, or multiple sockets. A symbol 820 may be used to indicate the location of an overhead can light or other type of lighting fixture. A symbol 830 may indicate the location of a power switch. Other symbols representing devices that are part of the building automation system (e.g., components of automation system 100 of FIG. 1, as described above), or part of the electrical wiring of the building may be displayed.

In one embodiment, a first type of symbol may represent a component that is part of the automation system (e.g., automation system 100 of FIG. 1), and a second type of symbol may represent a component that is not part of the automation system. Thus a user installing the component devices of the automation system could determine, for example, that some of the outlets are to be smart outlets (e.g., outlet 130 of FIG. 1, as described above), and other outlets may be traditional outlets that are known in the art. The different types of symbols may be distinguished using different colors, highlighting, or any other visual indicator to denote which symbols correspond to components that are part of the building automation system and which symbols correspond to components that are not part of the system. The user may have an option to choose to display only components that are part of the automation system or only components that are not part of the automation system.

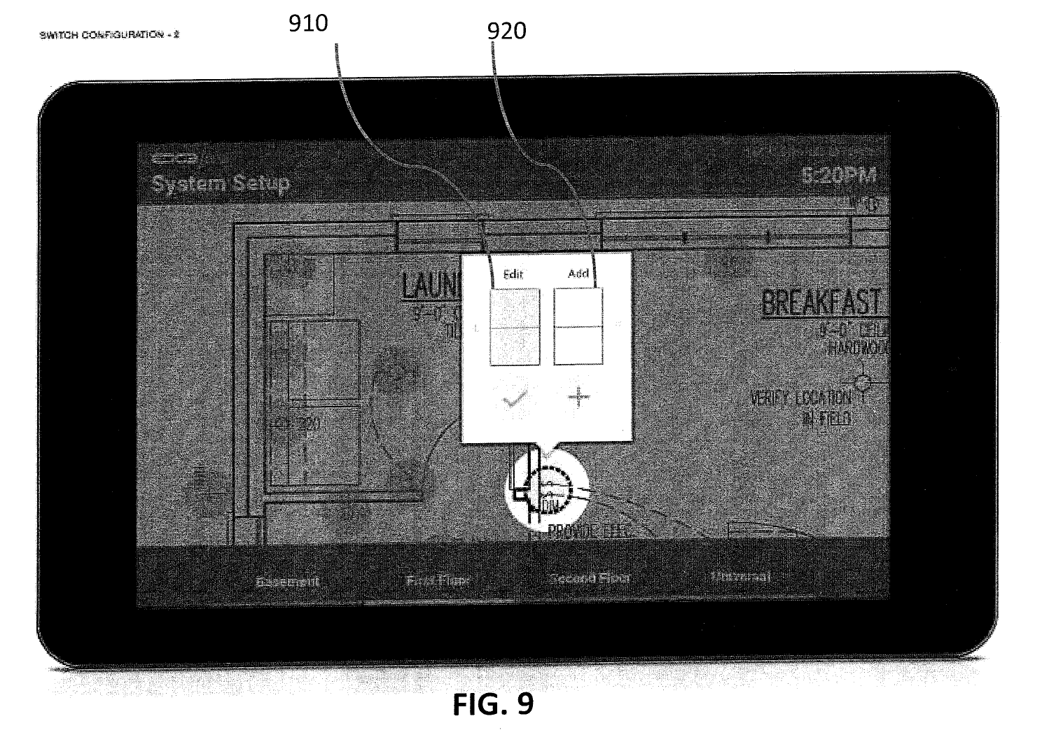

FIG. 9 depicts an exemplary screen of the mobile application's GUI for highlighting a selected component to be configured for the building automation system. In the example of FIG. 9, the user may have selected a switch. As shown in FIG. 9, this particular switch includes two physical switches 910 and 920. The highlight and checkmark for switch 910 on the left-hand side may indicate that this switch has already been configured. However, it should be noted that this can be visually represented and displayed to the user using any of various visualization techniques. In this example, in addition to highlighting the symbol for switch 910 and including a check mark displayed beneath the symbol, an “Edit” label is also displayed above the symbol for indicating that the user may select the switch to edit information. Any other suitable visualization technique(s) also may be used to indicate that switch 920 has not been entered or configured. In the example shown in FIG. 9, the switch 920 is not highlighted or filled with any color or shading, and a plus sign is depicted beneath the switch symbol, while the word “Add” is shown as a label above the symbol. Thus, referring back to step 420 of method 400 shown in FIG. 4, the user may, for example, select switch 920 at step 420.

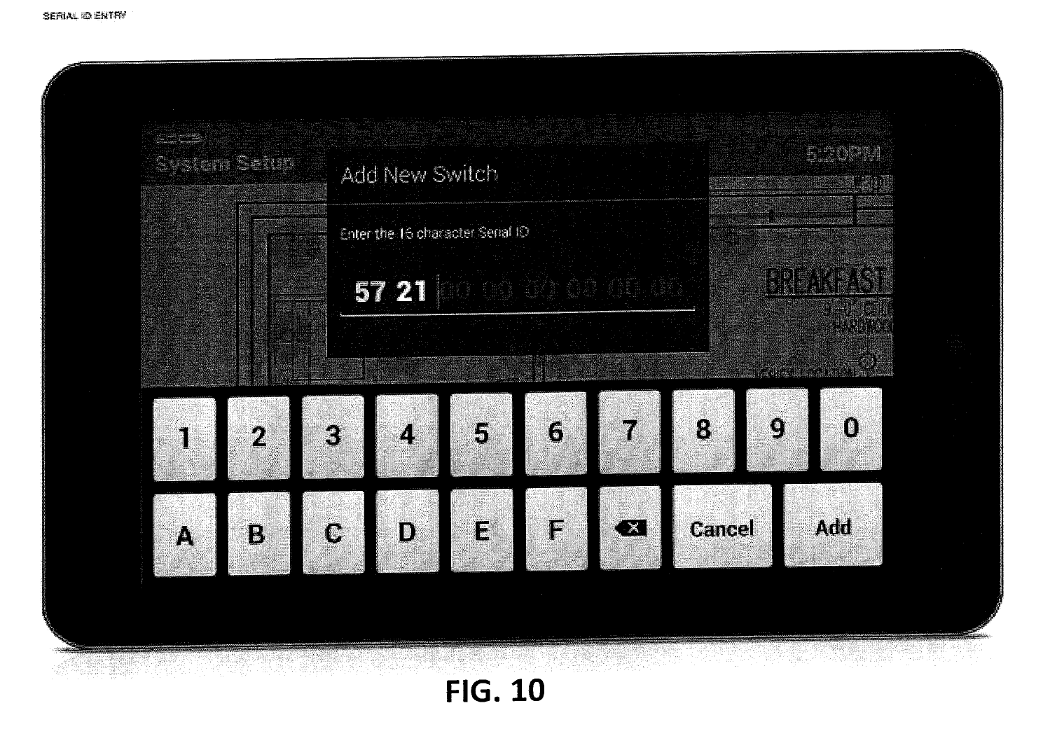

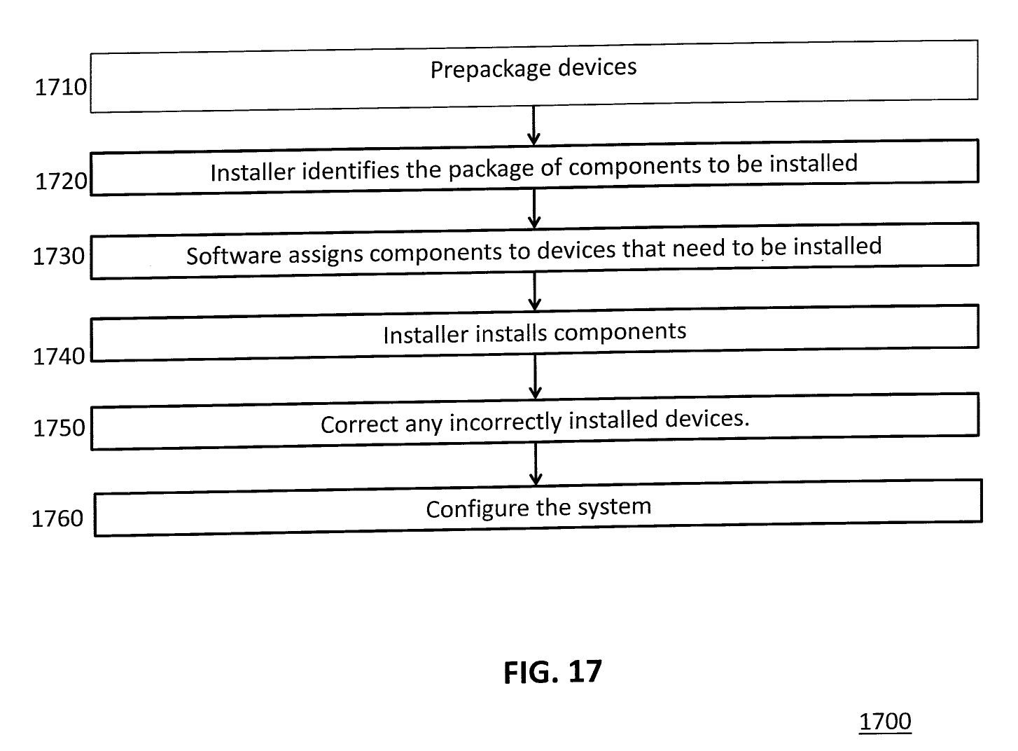

In step 430, the user may provide information identifying the particular switch being installed, e.g., at a predetermined location within the building, which may be known to the automation system (e.g., automation system 100 of FIG. 1, as described above). Such identification information may include, for example, a serial number associated with the physical switch being installed at a selected location. Such a serial number may be any numeric or alphanumeric sequence or code associated with a component of the automation system that uniquely identifies the component. The serial number associated with a component may be assigned by, for example and without limitation, the component's manufacturer, a distributor, or other entity associated with the automation system, the component, or a prepackaged set of components (as will be described in further detail below with respect to FIG. 17) in which the component may be included. In an example, the serial number may be manually entered by the user via an input field of the screen of the mobile application's GUI, as shown in FIG. 10. Since the user's device in this example may be expecting a serial number for a switch (e.g., switch 920 of FIG. 9, as selected by the user in step 420 of method 400 described above) to be installed, the serial number may be prepopulated with part of the serial number associated with a switch. In this example, the number “57” may be expected to begin all switch serial numbers. The number “57” therefore may be highlighted, e.g., in a particular color (e.g., green) and the user may be prompted to enter the remaining digits of the serial number. In FIG. 10, as the user may have manually entered the digits “21” into the input field, these digits may be shown in a different color or visually differentiated in some other way from the digits (e.g., “57”) that are automatically populated by the application. If the user changes the 57 to another code, the device may change the symbol to match the device type corresponding to the new code entered by the user. The serial number may be entered by the user via a keyboard or other user input device of the user's device. For example, the device may have a camera that may be used to capture a picture of the serial number (e.g., as imprinted on the physical automation system component being installed or configured) or that includes electronic information corresponding to the serial number. Such information may be derived from various sources including, but not limited to, a QR code, one or two dimensional bar code, or the written serial number. The code may be included in a tag or plastic overlay on the component, which may be removed during or after installation. The component may have a RFID tag or other wireless communication part that enables the devices to read the serial number from the component to be installed.

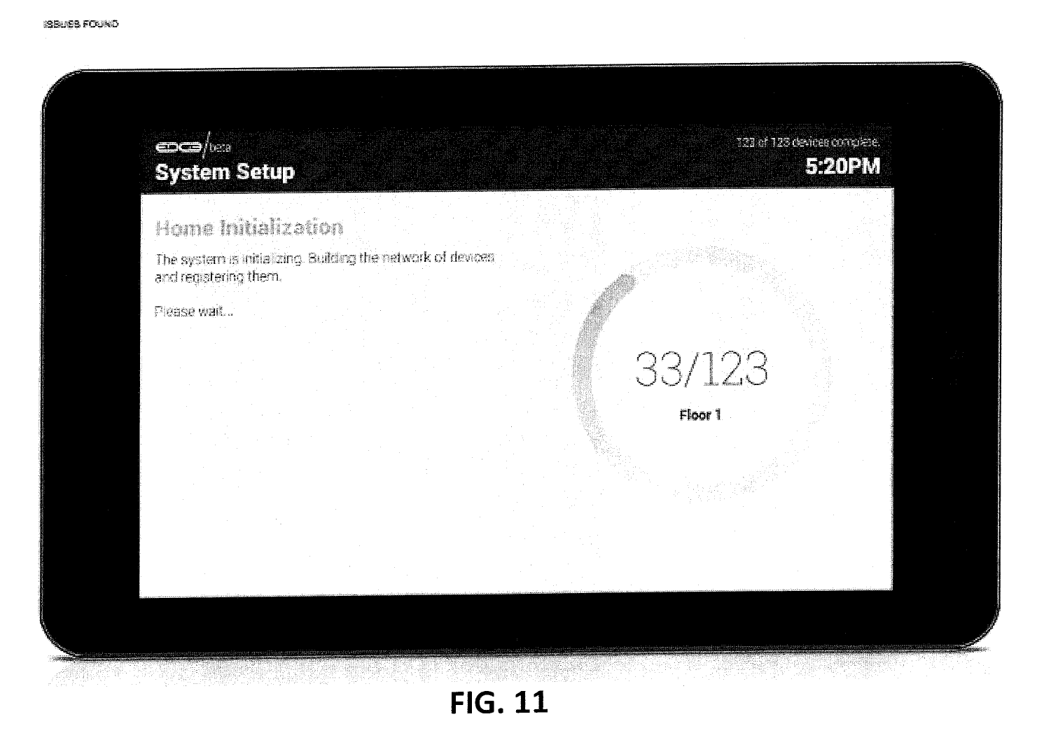

In step 440 of method 400 shown in FIG. 4, the user's device (or application executable at the device) causes at least some of the components that have been installed to be configured. FIG. 11 shows an exemplary screen of the mobile application's GUI, which may be displayed to the user while the configuration of the automation system is under way, e.g., components are being initialized based on settings provided by the user, as described above. It should be noted that the configuration of one or more components of the automation system may occur at different times or various intervals over the course of a given period of time (e.g., during breaks after each component is entered, or between different shifts or installation sessions). During the configuration process, the user's device or another component of the automation system may attempt to communicate with one or more of the installed system components that are part of the automation system (e.g., automation system 100 of FIG. 1, as described above). The corresponding blueprint data may include information on associations between different system components, and this data may be transmitted to the appropriate components. Switches to control, for example, the garbage disposal, lights in a hallway, or lights in a room may be associated or paired with the outlets, fixed lights, or other relevant components as envisioned in the blueprint.

In some embodiments, the control unit 110 may determine that a device should be remapped. The control unit 110 may determine that an outlet will be controlled by a switch. The control unit may communicate to the outlet and/or the switch to indicate the new control paradigm. After the communication by the control unit, the switch will communicate to the outlet to effect control over the outlet. The switch may communicate to the outlet directly, or the switch may communicate to the outlet through one of more devices of system 100. In some embodiments, the devices may be WIFI hubs or other sources of a WIFI signal.

During the configuration process, as described above with respect to steps 410, 420, 430, and 440 of method 400, the automation system in this example may determine that messages need to be relayed to certain devices for various reasons. In an example, the user's device may attempt to communicate with a component of the automation system, such as an outlet 840, as shown in FIG. 8. If the user's device determines that it cannot communicate directly with outlet 840 (e.g., if outlet 840 does not have wireless communication capabilities), the user's device may communicate with one or more other components that are known to be in communication with the outlet 840 in order to send a request for the component(s) to relay a message to outlet 840. If outlet 840 responds to the component(s) with its own message, the component(s) may then relay the response from outlet 840 back to the user's device. Thus, for example, the outlet 810 may act as an intermediary for sending or relaying messages between outlet 840 and the user's device. The user's device may then store information indicating that communication with outlet 840 can be established, so long as messages are passed through outlet 810.

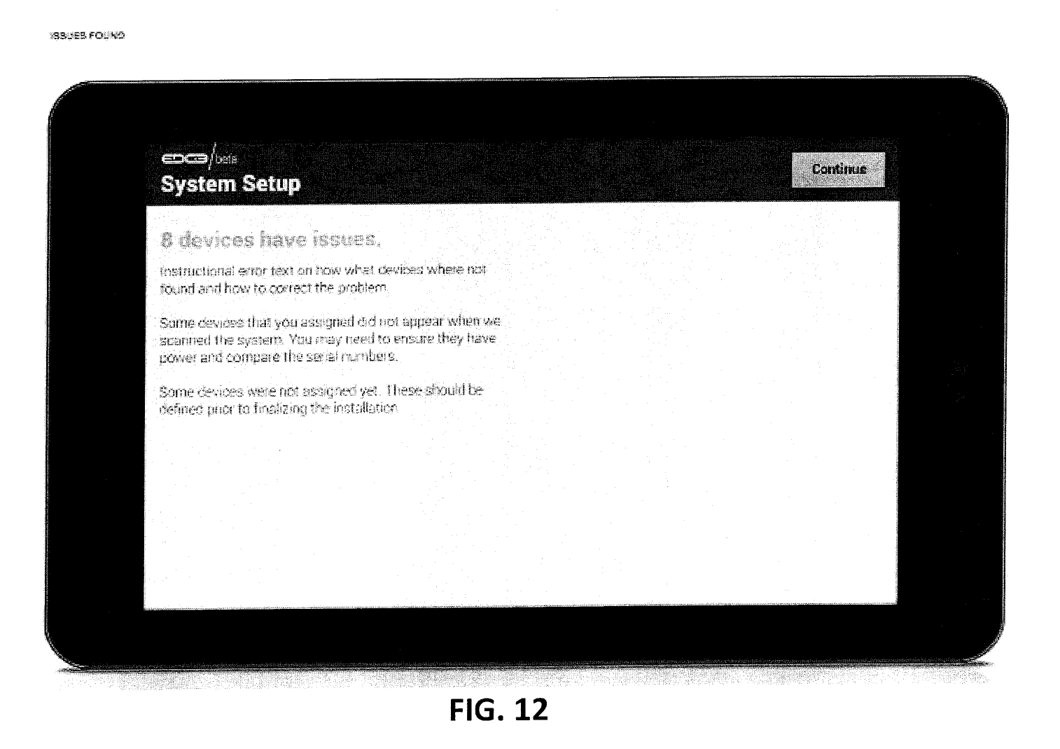

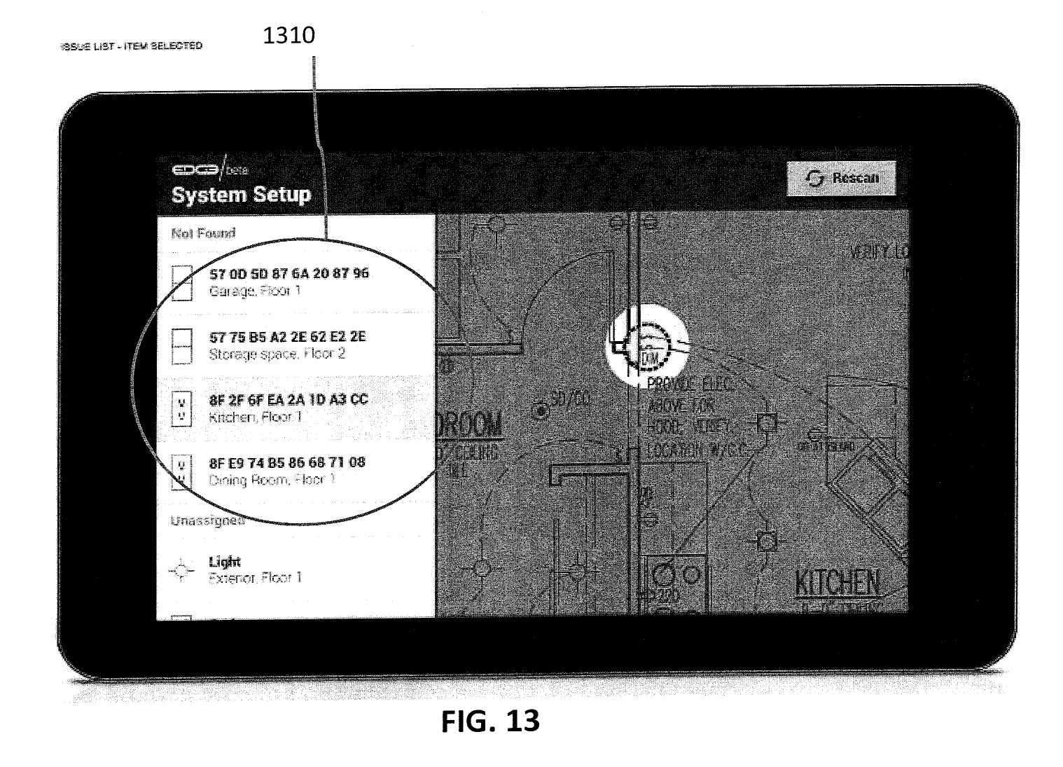

During step 450 of FIG. 4, the user's device may display information on the success or failure of the configuration of any automation system components, as shown by the exemplary screen for the mobile application's GUI in FIG. 12. FIG. 12 shows an example of eight devices or components of the automation system not correctly configuring. The components in this example may not have been installed yet, may not be functioning properly, or may otherwise be out of communication with the user's device. FIG. 13 depicts another exemplary screen of the mobile application's GUI, which provides a more detailed view of components that may have issues to be resolved during the configuration of a building automation system. As shown in the example of FIG. 13, a list 1310 indicating the automation system component devices that have not configured correctly may be shown. The user may then investigate the automation system devices shown in list 1310 to determine the source of the problem, e.g., why they are not communicating properly. Potential sources of problems may include, but are not limited to, an incorrect or mismatching serial number for the component (e.g., the serial number may have been entered incorrectly by the user), or other problems that may be preventing communication between the component and the user's device. The mobile application's GUI may allow the user to select the device in order to view more information that may be displayed about the failed component, such as the component's exact location within the building and desired function, which may assist the user in diagnosing and resolving the configuration issues.

FIG. 4 illustrates a method of identifying the serial number (or other identifying characteristic) of a device installed in an automation system 100 to the system. In another embodiment, the installer may choose a device to be installed, scan the serial number using a device such as mobile device 170, and the mobile device may adjust the image in the display to illustrate where the device may be installed. The serial number may be scanned (or determined) with a camera, RFID, or by other means as are known in the art.

In some embodiments, a component of the automation system may be configured as soon as the serial number of the component is entered by the user, as described above with respect to FIG. 10, so that the user installing the component has immediate feedback if there is an installation issue with the component.

In some embodiments, switches which are not assigned to control something may be identified as a problem. It is expected that most switches that are installed will have a function assigned to them. If a switch does not have a function assigned to it, this may be indicated to the user via a message or warning displayed within the mobile application's GUI at the user's device. Similarly, if an outlet of the automation system (e.g., outlet 130 of automation system 100 of FIG. 1, as described above) is determined not to be coupled to a switch, a message indicating this to the user may be displayed to the user via the GUI of the mobile application.

In some embodiments, any automation system components (e.g., lighting devices) that do not have switches assigned to control them may be flagged as errors. An example would be a canned light fixture in a ceiling. In most installations, it may be expected that this lighting device should be controlled by a switch. The blueprint or file loaded during step 410 of method 400, as described above, may include, for example, a list of devices that must be paired to another device or may otherwise indicate which device must have a paired device.

In other embodiments, some devices including, for example and without limitation, overhead fluorescent lights in an office space, may be controlled by a control unit (e.g., control unit 110 of FIG. 1, as described above) of the automation system (e.g., automation system 100 of FIG. 1), which may control the lights based on one or more various parameters including, but not limited to: time, ambient lighting conditions, occupancy (e.g., as detected by one or more sensors of the automation system), day of the week, or user interface input received by the control unit, e.g., from the user's device based on the user's input received via the GUI of the mobile application executable at the user's device. Accordingly, these devices may not need to be paired to a switch during installation in order to for the devices to be configured and function properly. The blueprint data loaded in step 410 may include information about which devices do not need to be paired to a switch or to other devices.

In some embodiments, components that have not been found may be grouped and displayed together within a list, similar to list 1310, as shown in FIG. 13. Other components, which may not have been entered by the user (e.g., the user has not provided a serial number or other information identifying the components), may still be known to the mobile application as being associated with the automation system (e.g., based on component data included with the blueprint file obtained for the particular building and/or automation system, as described above). In a further embodiment, the mobile application may be configured to notify the user of any missing components, e.g., any components that have not been entered or identified by the user but that are known to be associated with the automation system for the particular installation project. In an example, any automation system components that are supposed to be installed for a particular installation project may be indicated to the user via the mobile application's GUI. In some implementations, such components may be graphically represented on the digital blueprint displayed to the user via the GUI (e.g., in a different color or shade) so as to indicate their appropriate installation locations within the building. These other components may be separately grouped and displayed in another list. In other embodiments, the components of the automation system located within the same room may be grouped and displayed together. In further embodiments, automation system components displayed within a list may be grouped by type or other user-defined category, for example, one or more lists displaying installed components in which all the outlets are grouped together and all the switches are separately grouped together.

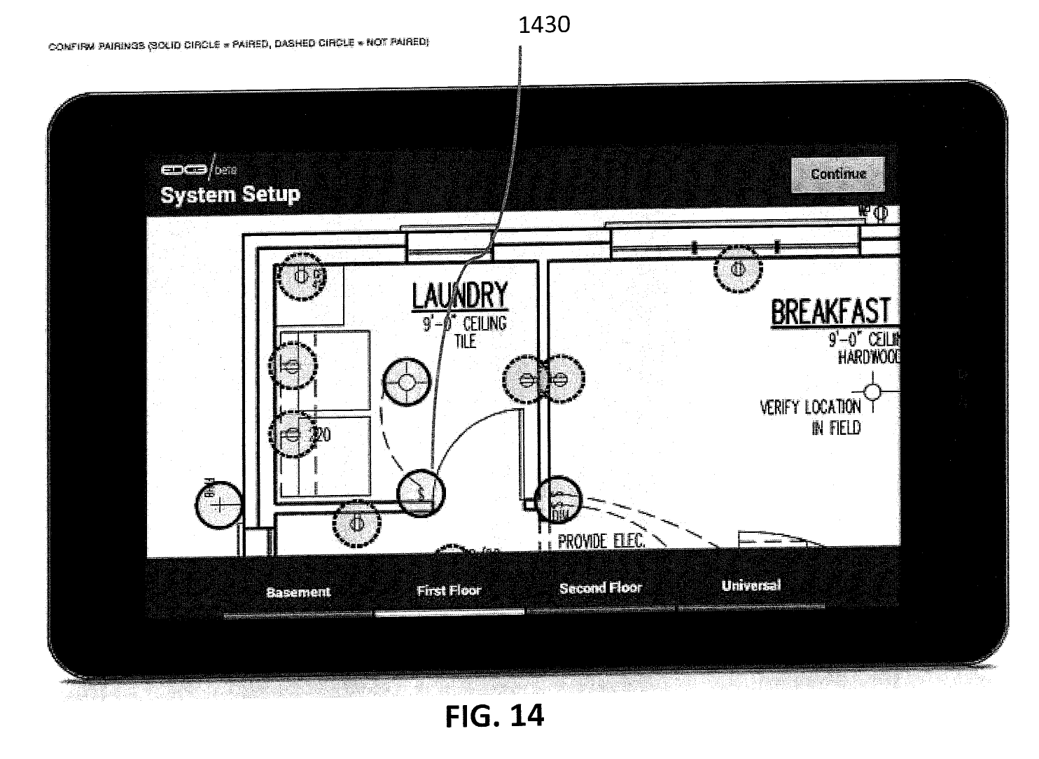

FIG. 14 depicts an exemplary system set up screen of the mobile application's GUI, which may be used to alter the preconfigured associations of components of the building automation system, in accordance with an embodiment of the present disclosure. As shown in FIG. 14, some components, such as a switch 1430, are displayed using solid exterior lines, which may indicate that these components, including the switch 1430, have been configured. Other components are displayed using dashed lines, which may indicate that they have not been configured. Any number of various visualization techniques may be used to visually indicate the status of each component of the automation system to the user. Examples of such visualization techniques include, but are not limited to, using different icons or symbols with different colors, shapes, sizes, etc.

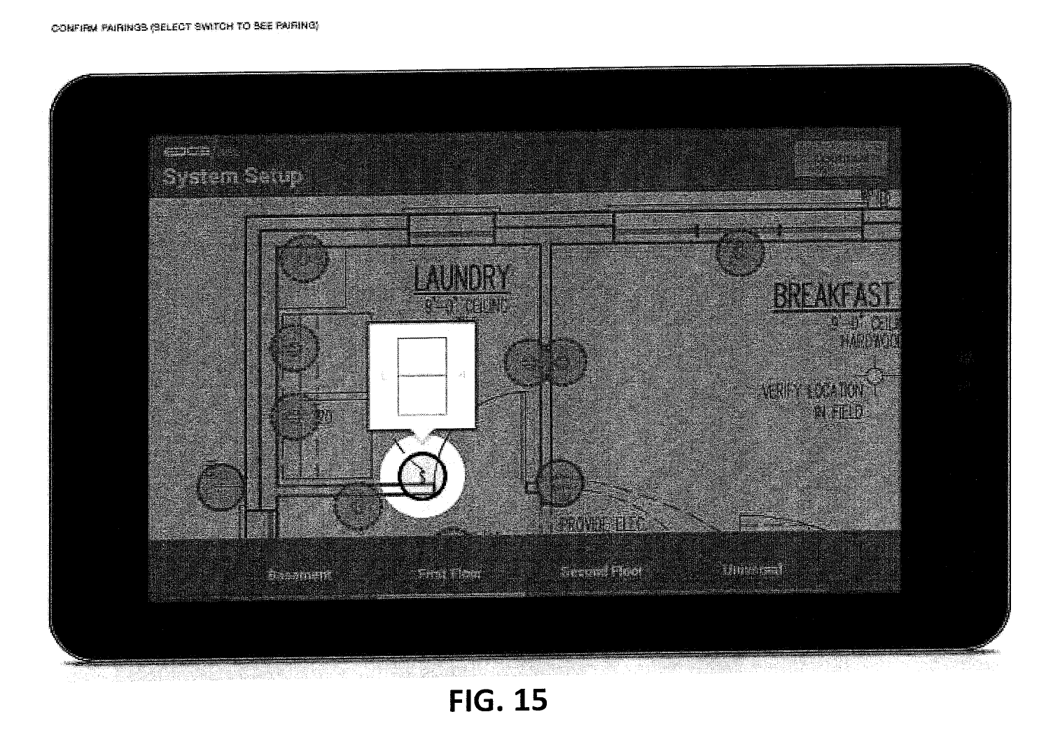

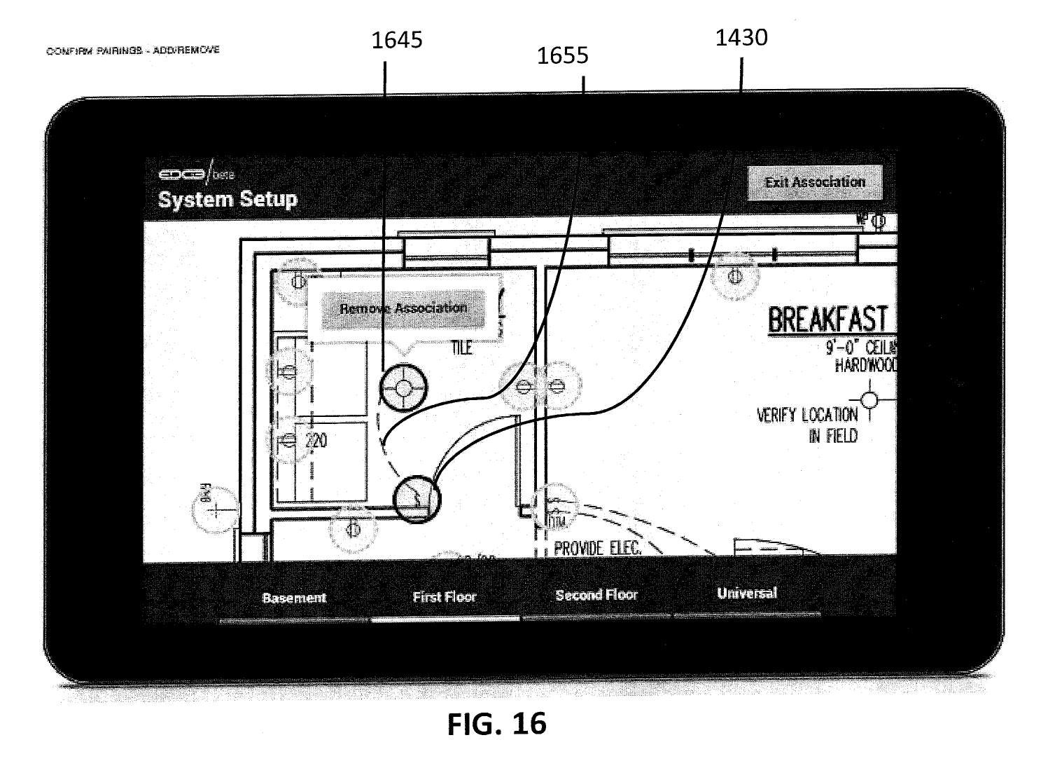

Referring back to FIG. 4, step 460 of method 400 may include providing the user with an option to remove or modify a pairing between different components of the automation system. For example, the user may have selected switch 1430, as shown in FIG. 14 and again in FIG. 16, as will be described below. The mobile application's GUI may then highlight or otherwise visually indicate the user's selection, as shown in FIG. 15. FIG. 15 depicts an exemplary screen of the mobile application's GUI, which indicates that a single component (e.g., switch 1430) has been selected by the user device for configuration. After selecting switch 1430 via the GUI, the user may be able to cause the GUI to display any associations (including any predetermined or default associations) or pairings between switch 1430 and other components of the system, as shown by the exemplary screen in FIG. 16. As shown in FIG. 16, the default association for switch 1430 may be to a ceiling or overhead light 1645. The association may be indicated by a line 1655, as shown in FIG. 16. The indicated association may signify that the switch 1430 is intended as a control for the overhead light 1645. The GUI may also display a user control button (labeled “Remove Association”) within a pop-up box in order to allow the user to remove the association between switch 1430 and overhead light 1645. The GUI may further allow the user to select other components to create new associations or modify existing associations so as to customize the building automation system's (e.g., automation system 100 of FIG. 1) setup for the specific location. Other user interface features may allow the user to move components to different locations, e.g., by dragging and dropping the corresponding symbols to the appropriate positions within the electronic blueprint displayed via the GUI at the user's device. Still other user interface features may allow the user to add or delete components to the system. This would enable the user to modify the placement of components to reflect any customization that may be desired (e.g., by the builder or future owner) for the specific location.

In some embodiments, a work or change order may be generated at or off the job site. The change may require an approval, and after any needed approval is obtained, the information may be transmitted to the user's device, including any other devices being used by the user to be informed of the approved change.

FIG. 17 depicts a flowchart of an exemplary method 1700 for installing and configuring prepackaged component devices of a building automation system, in accordance with an embodiment of the present disclosure. Method 1700 may be an alternate technique for installing building automation system components in a location. In step 1710, the user may prepare a set of prepackaged components of the automation system to be installed. The components within a prepackaged set may include, for example and without limitation, one or more outlets (e.g., similar to outlet 130 of FIG. 1), one or more switches (e.g., similar to switch 120 of FIG. 1), a control unit (e.g., control unit 110 of FIG. 1), and any other components that may be associated with the automation system (e.g., automation system 100 of FIG. 1). The package may include some or all of the components needed for installing at a location (e.g., within one or more floors or rooms of a building). The components of the system may be included within a single package or may be separated into multiple packages for shipping and handling convenience. A package of components may include corresponding groups of different components that may need to be paired, for example, five outlets and five switches. A package may consist of one type of device, for example, three outlets.

When the devices are packaged, the serial numbers of the devices would be recorded and associated with a packing number and/or with a position in the package. For example, a package may include two switches and two outlets. When packaged, the serial numbers of the two switches and two outlets may be known or read from the devices. The switches and outlets may each be assigned an identification number related to the package, such as Outlet #1, Outlet #2, Switch #1, Switch #2, or A, B, C, D, or any other labeling scheme. These components also may be positioned within the package in a specific order which may be labeled, such as Position #1, Slot #2, etc. The labels and/or position locations of each component within the package are associated with electronic serial numbers, as noted above. The association between serial number and component label may be stored on a separate label for the package itself, in a database or server accessible via a network, or in an electronic tag, such as a RFID or NFC tag.

In step 1720, the user performing the installation (or “installer”) identifies one or more packages of components to be installed. The identification of each package can be performed by using, for example, a handheld device (e.g., mobile device 170 of FIG. 1, as described above) coupled to an infrared (IR) scanner to scan one or more bar codes physically located on the package or an electronic invoice associated with the package. However, it should be noted that any one of various techniques may be used for identifying each package based on a reference code or unique identifier associated with the package. For example, the user's handheld device may be configured to scan or read a unique RFID code (e.g., using an RFID tag reader), an NFC code (e.g., using an NFC tag reader), or one or more QR codes (e.g., using a digital camera) printed on the package for identification purposes. Alternatively, the user may manually enter a code associated with the package via a GUI of the mobile application executable at the device, as described above. The codes or package identifier information may include the electronic serial numbers of various components included in the package and their associated positions within the package. Such information may also include associations between each component and package-specific labels, e.g., related to the identification labels and positions assigned to the components within the package, as described above. In some implementations, the codes or identifiers for a package may be used by the user's device to access a database via a communication network (e.g., cloud 140 of FIG. 1) and retrieve the electronic serial numbers for components within a particular package along with the associations between the components and their respective positions within the package or their package-related labels.

In step 1730, the mobile application executable at the user's device may include an installation feature that assigns the identified components in the identified package to components that need to be installed at particular locations within the building (e.g., based on the blueprint specifications received for the building and automation system, as described above). The assignment may be performed automatically by the application software, manually by the user, or by a combination of the user and the software. For example, the software may identify the location of the user with respect to a selected floor or room within a building and assign the components of the package to components that need to be installed at locations in the vicinity (e.g., within a predetermined radius) of the user or within the same room as the user. The user's location may be determined based on location data captured by, for example, a GPS of the user's device or other location determining technique available to the device. The GUI of the mobile application may allow the user to specify a particular location or area within the building at which various components within a package are to be installed. The mobile application software may then automatically assign the identified components of the package to specified automation system components (e.g., as specified by component data associated with the blueprint file for the building and automation system, as described above), which need to be installed at the indicated location or area. In an embodiment, the GUI of the mobile application software may display a list of components in the package identified in step 1720 and allow the user to associate each component from the identified package with the corresponding component (or component symbol) graphically represented on a digital floor plan or blueprint displayed to the user at the device. The displayed map or floor plan may be based on, for example, the location information derived for the user's device and the component data associated with the blueprint information or file loaded for the building and automation system, as described previously. In an example, the GUI may provide controls enabling the user to specify the components from the identified package to be installed, e.g., by dragging and dropping representations of the components from the identified package onto the matching symbols or representations of the components that the user intends to install at various locations, as shown on the digital floor plan displayed to the user at the device. When an association for a component is made by the user in this way, the application software may be configured to automatically determine the electronic serial number of the component based on the information associated with the identified package and further, associate the serial number information of the component with the component, as represented on the digital floor plan or blueprint. It should be noted that the user also may be able to manipulate the component representations as displayed via the GUI in order to change the locations and associations of selected components, as may be desired for a particular installation or setup.

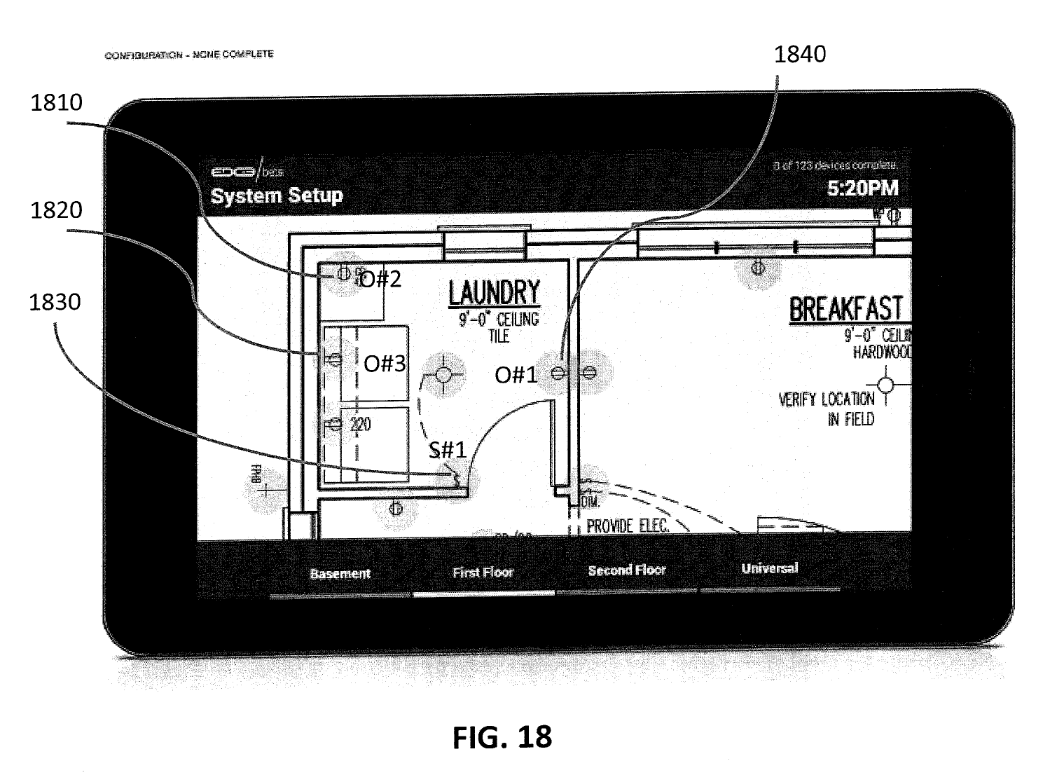

FIG. 18 depicts an exemplary setup screen of the mobile application's GUI, which indicates the locations of prepackaged components to be installed for a building automation system, in accordance with a further embodiment of the present disclosure. In an example, the exemplary setup screen of FIG. 18 may be displayed to the user after the user has finished scanning a code from a package of components (e.g., including three outlets and one switch). The types and locations of each component may be determined based on information associated with each of the components (e.g., including electronic serial numbers of the four components), which may be automatically retrieved by the software by accessing a database via a communication network (e.g., cloud 140 of FIG. 1). One of the outlets is identified in FIG. 18 as Outlet #1 or O#1. This component is associated with an outlet 1840, and the representation of outlet 1840 on the drawing includes a label “O#1,” which may be the label assigned to the component within the package, as described above. The serial number and label for the component to be installed at outlet 1840 may be retrieved by the software from an information table of the database that is associated with the automation system (e.g., automation system 100) being installed, as described above. Thus, the appropriate label (“O#1”) and serial number associated with a component corresponding to a particular position in an identified package may be used to properly identify and locate the component during the installation of the automation system, without requiring the user to tediously enter this information manually. The labels and serial numbers for outlet 1810 (labeled “Outlet #2” or “O#2”), outlet 1820 (labeled “Outlet #3 or O#3”), and switch 1830 (labeled Switch #1 or S#1) may be determined in a similar manner.

Referring back to FIG. 17, in step 1740 of method 1700, the user installs each component, e.g., by removing each component from the package, confirming the identity of the component based on the information printed on a physical label on the package or component itself, and then installing the component in the appropriate location. All components from the package may be associated and installed in a similar manner, as described above.

If the user incorrectly installs a component in the wrong location, the mobile application's GUI may provide the user in step 1750 with user interface controls to correct the information. The correction can be made by the user via the GUI, for example, by selecting the correct component that was supposed to be installed from the identified package (e.g., as displayed in a component list for the package via the GUI, as described above) and dragging it to the appropriate location (e.g., corresponding to the component that was installed by mistake), as indicated on the digital blueprint displayed to the user. The application may then automatically transfer the electronic serial number of the correctly installed component to the new location. This would prevent the user from installing a component at a location other than its appropriate location, which may be pre-assigned based on specifications or parameters defined for the particular building and automated system, e.g., as identified by the blueprint data previously loaded into the user's device.

After some or all of the components have been installed, the system (e.g., via control unit 110 of FIG. 1) may attempt to configure the devices in step 1760. The system would attempt to communicate to the components and preconfigure associations that are indicated by the digital blueprint information. Any problems such as those related to communicating with the components or missing components may be indicated to the user via the GUI.

The benefits of this exemplary method 1700 may therefore include, but are not limited to, enabling the user to efficiently install and configure components of a building automation system. For example, the user may pull a component from a packaged box, check the label or number associated with the component (e.g., “1” or “Kitchen Light Switch #1”), and install it in the correct junction box or location with a minimal amount of manual user input. The user's handheld device would then display the drawings of the location and the identification number associated with each component that needs to be installed. Since the serial number of the components to be installed are already known (e.g., based on information stored in a database accessible to the user's device), this saves the user from having to spend additional time for manually entering this information.

In some embodiments, the installer or another authorized person may pre-populate devices on the map, and indicate where each device should be installed, where the devices may be identified by serial numbers. The function of populating devices on the map may be performed away form the job site.

In some embodiments, the installer may have a container of prepackaged devices. This could for example be a blister pack containing 5 outlets such as outlet 130 and 5 switches such as switch 120. An installer may scan a code on the package using a handheld smartphone such as 170. The information may be entered manually through a user interface, or a code such as a QR code may be scanned, the device 170 may read a RFID tag located in the package. The code may indicate or point to the serial numbers and identities of the devices in the pack. The installation software may then assign the devices to uninstalled switches and outlets in the location where the automation system 100 is being installed. The installer can then pull devices out of the package and install them in the locations indicated by the device 170.

When devices are prepackaged, a group of devices may be accumulated into a group to be packaged, the serial numbers of the devices may be recorded, and the devices may be labeled with an identification number associated with the package. A package of 5 outlets such as outlet 130, may have the serial numbers of the 5 outlets recorded and associated with numbers 1, 2, 3, 4, and 5. The outlets may each be labeled with 1, 2, 3, 4, or 5, or the outlets may be placed into the package where the location in the package is labeled 1, 2, 3, 4, or 5. The package is then assigned a unique serial number. By reading the serial number of the package, the serial numbers of the enclosed devices can be determined and loaded without the installer having to key in all 5 serial numbers independently.

In some embodiments, the components required for a subset of an installation job may be prepackaged together. For example, a hotel with 300 rooms may be built with each room requiring 4 switches, 8 outlets, and any number of other components of a particular automation system. The components for a room may be prepackaged, allowing an installer to collect a package, scan the identity, then quickly install the 12 devices (e.g., 4 switches, 8 outlets) in the same order as indicated by the mobile application executable at a mobile device carried by the installer. The automation system has the identity of the package, which points to or contains the identities of the components in the package, thereby allowing the automation system to load the devices and corresponding serial numbers and then, correlate the numbers to the locations at which each of the components were installed.

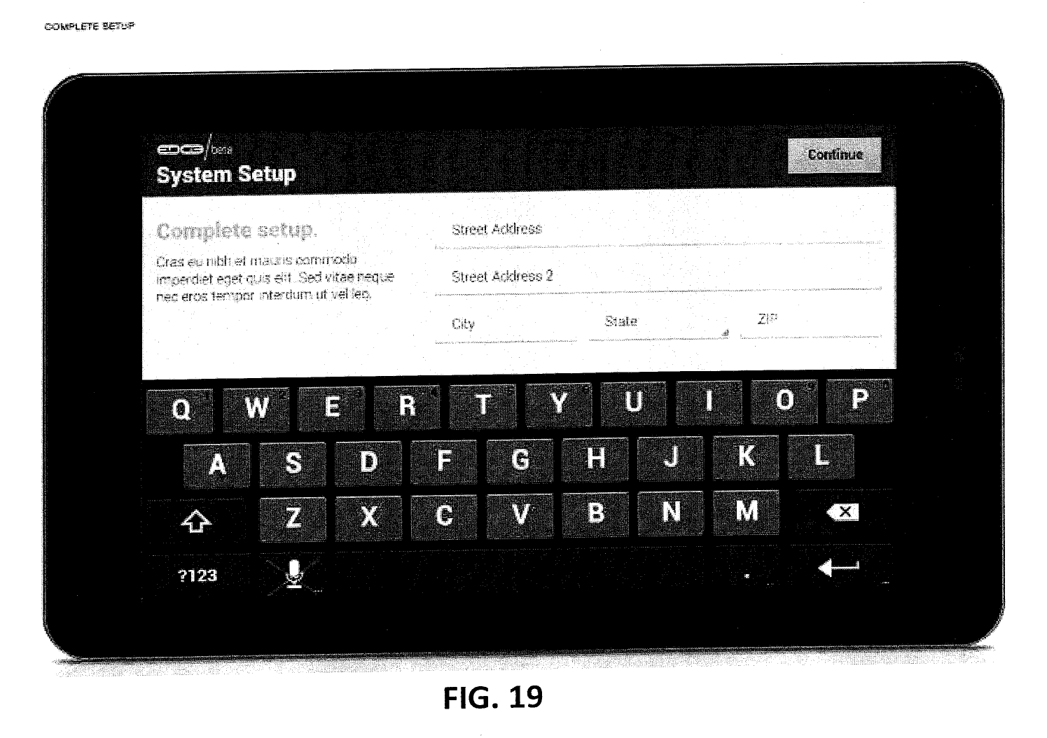

FIG. 19 illustrates an example of a screen to enable an installer to indicate the address or location of the house, building, apartment, office, or facility that will be associated with the automation system.

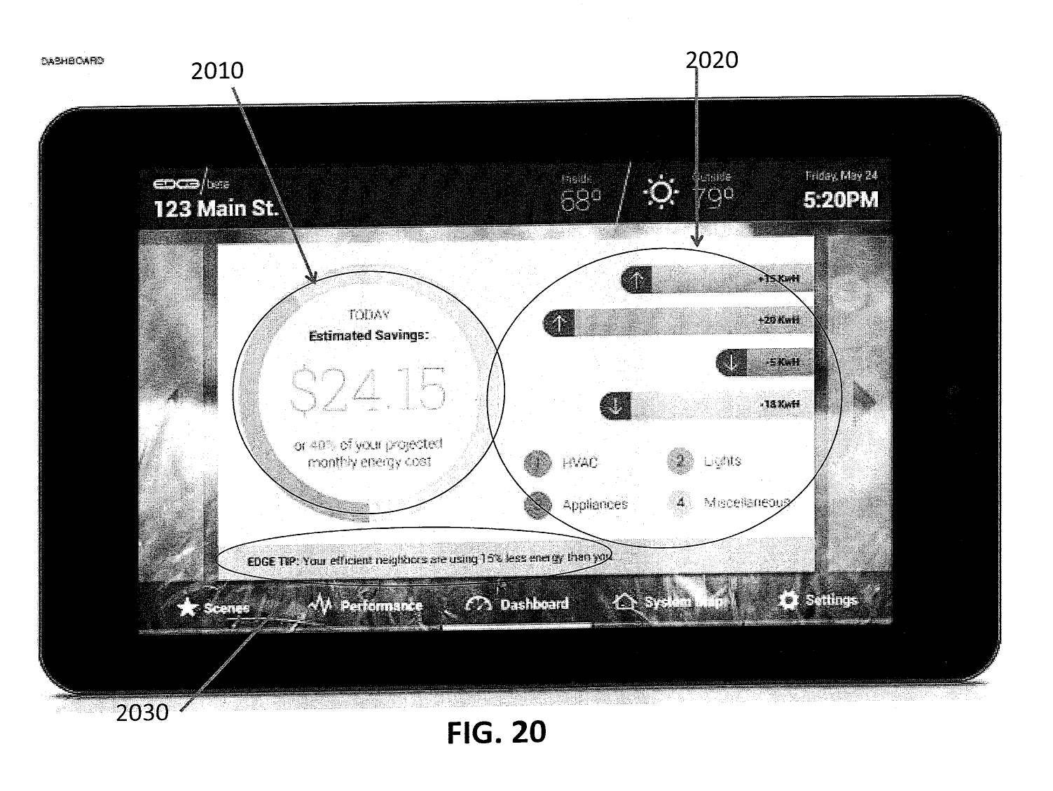

FIG. 20 depicts an exemplary home screen of the mobile application's GUI, which may be displayed to a user for showing status information for configured component devices of a building automation system, in accordance with an embodiment of the present disclosure. For example, the exemplary home screen shown in FIG. 20 may be displayed to a user as part of a mobile application associated with an automation system (e.g., automation system 100 of FIG. 1). As shown in FIG. 20, a display element 2010 may be used to indicate the energy savings over a predetermined period of time (e.g., for the particular day, week, month, etc.). The energy savings displayed to the user may be relative to the energy usage of the previous day or any other prior day (e.g., the same day last week, or the same day last year) for which energy usage information is available. Alternatively, the displayed energy savings may reflect an average of energy used over a previous period of time. The element 2010 shows cost savings, but it may also show increased cost if the energy cost has increased. The estimated savings could be in a particular currency, units of energy used, units of an utility used, or the usage may be converted to a unit unique to the user, as disclosed in U.S. application Ser. No. 14/012,846, titled “Personalized Incentive Systems, Devices, and Methods,” which was filed on Aug. 28, 2013 and is incorporated herein by reference in its entirety. A graph depicting energy savings or costs information may also be customized, for example, to ignore certain days. For example, if the automation system is installed in an office building that is closed on Saturdays and Sundays, the display element 2010 may only reference Monday through Friday information.

Also, as shown in FIG. 20, a feature 2020 on the display may be used to show a representation of the existing usage data. Feature 2020 may be used to visually indicate the relative data usage between different system components or categories of components. In this example, the lights are shown as drawing the most power; heating, ventilation, and air conditioning is drawing the third highest power; appliances are drawing the lowest power; and components in the miscellaneous category are drawing the second most power. In some embodiments, the “Miscellaneous” category may be used to display a sum of all the power being used by system components that cannot be grouped in a single category or be displayed as a dedicated item or graphical element via the GUI. While this example shows 2020 as depicting electric power usage, the display item may also show, water, natural gas, or other utilities that are used. The graphs may represent the quantity of the utility used, cost of the utility used, a combination of cost and quantity, or another measure of the utility used or saved.

In some implementations, a feature 2030 may also be displayed to show a short suggestion or comment on the energy usage. This could be a suggestion on how to reduce usage, save money, status of a contest to reduce utility usage, or another comment related to the automation system in this example. The text displayed via feature 2030 may be different depending on which user is determined to be viewing the display, e.g., as determined from identification information provided by or derived from the user, as described previously.

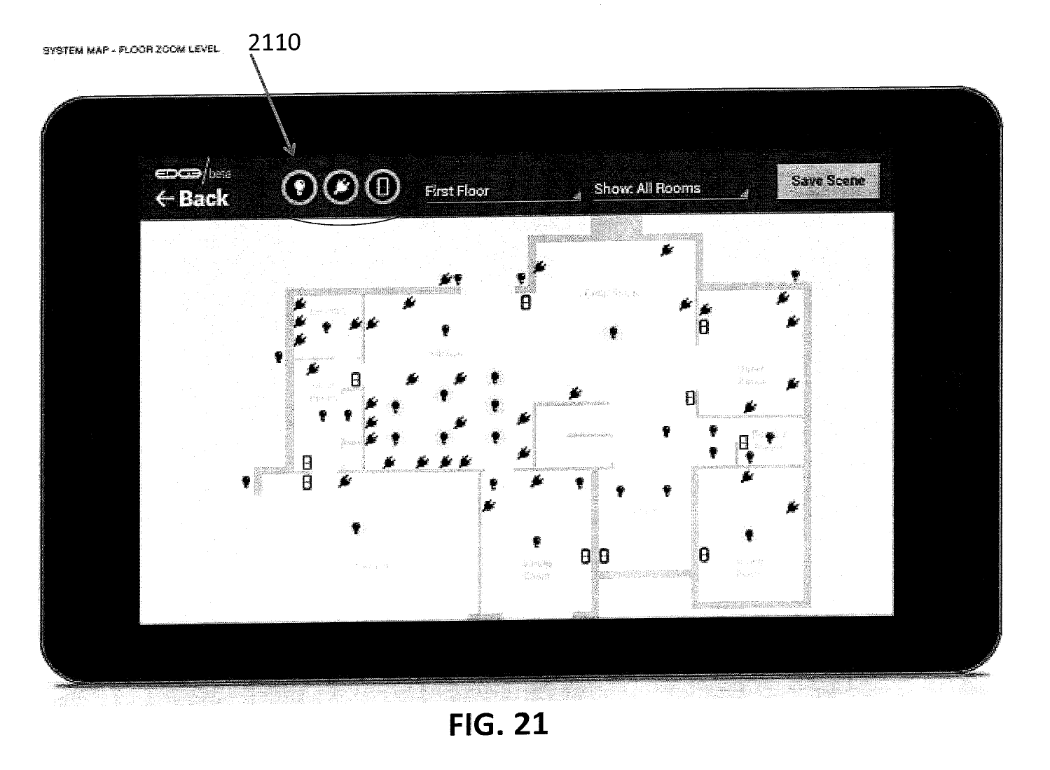

FIG. 21 shows another view that may be displayed to a user as part of an embodiment of the present disclosure. The display may show a floor, multiple floors, or part of a floor. Element 2110 shows three icons, including a light bulb, a plug, and a switch. By selecting or deselecting the light bulb icon via element 2110 of the GUI, the position of lights may be shown on the digital floor plan or blueprint displayed to the user. By selecting or deselecting the plug icon of element 2110, the positions of outlets may be shown or hidden on the digital floor plan. By selecting or deselecting the switch icon of element 2110, switches are shown or hidden on the floor plan. By toggling each of these icons of element 2110, the user may be able to view all aspects of the automation system, without adding too much clutter to the display. Lights that are presently powered on may be shown or visually represented on the digital blueprint differently than lights that are powered off Outlets with devices that are powered on also may be shown differently than outlets that are presently not supplying power.

The user may indicate multiple devices on the layout in FIG. 21. Devices may be selected in multiple rooms, or multiple floors. Once selected, the user may select “Save Scene” from the user interface. The settings of the selected components may then be recorded and stored. The user can optionally select an icon and/or enter a name to refer to the scene. At a later time, the user can recall the scene using the GUI of the mobile application or other user interface at a different computing device, and the previously selected devices may be restored to their previously stored states.

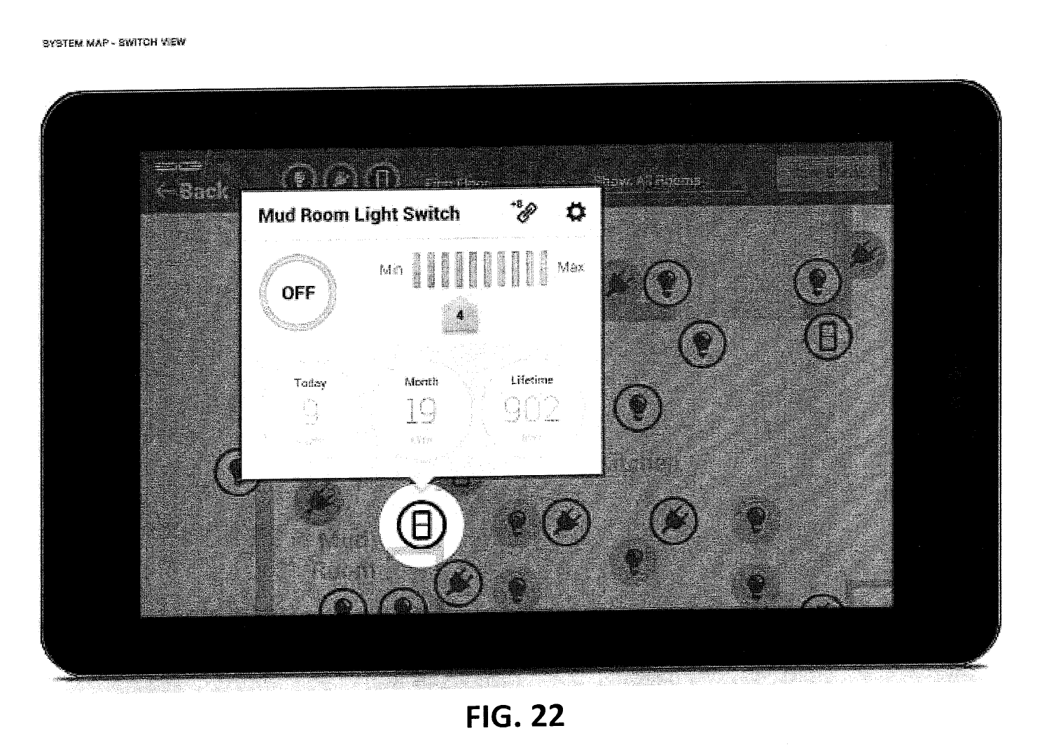

FIG. 22 shows an exemplary configuration screen for selecting and configuring one of the lighting devices displayed in FIG. 21. As shown in the example of FIG. 22, a pop-up dialog or window control may be displayed to provide the user with additional details on the selected item. The pop-up window may display text indicating the location, function, name, or other identification of the component, such as “Mud Room Light Switch”. The pop-up window may display the present status of the component, and allow the user to send one or more commands for turning the device off, on, or to any other valid state such as, for example, dimming. The pop-up window may also display statistics such as average utility usage for a particular period of time, e.g., the day, for a month, a week, and/or for a lifetime.

In some embodiments, the display may indicate that a bulb is burned out or broken. For example, if an automation system (e.g., automation system 100 of FIG. 1) causes power to be delivered to a light bulb, but the light bulb is not drawing power, this may indicate that the light is not functional, and the automation system may declare the light bulb broken. The icon of the broken light might indicate the broken status. The automation system in this example may also send a message to a user of the automation system requesting the user to purchase and/or replace the nonfunctioning component or device. Such a message may be sent by the automation system to the user via, for example, the GUI of the mobile application executable at the user's device, as described above. Additionally, in some embodiments, the system 100 may provide a notification if a battery in an element of the system 100 is approaching end-of-life and should be replaced. The automation system 100 may automatically order or otherwise request the battery in some embodiments. The automation system 100 may add the battery to a shopping or to-do list on a device such as device 170 associated with an authorized person.

In a further embodiment, the mobile application executable at the user's device may be used to manage or track the user's inventory and equipment that may be needed for a particular installation of an automation system. The inventory may include, for example, a list of all the automation system components that may need to be installed within an existing building or a new building at a construction site. Such inventory tracking functionality of the mobile application may enable the user to scan or otherwise provide the serial number for each component that is in the user's actual possession prior to starting an installation at the particular building or site. As described above, the user may scan a component's serial number or code, as printed on a label physically attached to the component or package, using a digital camera or IR scanner coupled to the user's device. Alternatively, the user may manually enter the component's serial number or code via a user input field of the mobile application's GUI at the device. The inventory list of components currently in the user's possession may be compared with a predefined list of components to be installed for a particular configuration of the automation system for the building. Such a predefined component list may be based on, for example, design specifications previously stipulated for the particular installation project by the installer's employer, a builder, or an end user (e.g., a building owner).

In some implementations, the user's device (or mobile application executable at the device) may be configured to automatically obtain component data including the predefined component list for a particular installation of the automation system from a remote data store or database via a network (e.g., cloud 140 of FIG. 1), as described above. Also, as described above, such component data may be obtained via the network along with digital blueprint information associated with the building and the automation system. In an example, the obtained data identifying the automation system components to be installed may be compared with the user's current inventory list or with a list of components that have been identified as being installed, and the user may be notified of any discrepancies, such as any components that need to be installed that may be missing from the user's current inventory. In some implementations, the component and blueprint data for a particular automation system and building may be used to estimate the amount of installation time that may be required for installing each component, group of components, or completing the entire installation project, based on prior time data associated with previous installation projects involving similar components and/or configuration parameters for the building automation system. Such prior data also may be tailored to the specific user/installer based on time data captured for the user during the user's previous installation projects.

In a further example, the mobile application's GUI may also provide an order screen enabling the user to order any missing components directly from the user's device. The mobile application in this example may be configured to communicate via a network with one or more product distribution services (e.g., hosted at one or more third-party servers) in order to fulfill the user's order. The user in this example may be able to use the mobile application to specify which components need to be ordered as well as a time and place of delivery. The application may also provide order-tracking features for the user at the mobile device, e.g., by communication via a network with one or more servers hosting the product distribution or order fulfillment services. Such tracking and management functionality may, for example, allow the user to plan for and meet the inventory requirements for a future installation project while using the existing inventory to complete a current project.

Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

It is understood that the present disclosure is not limited to the particular forms, embodiments, and/or examples illustrated. Alternatives and/or modifications of the systems, devices, and methods disclosed herein are contemplated and may be made without departing from the spirit and scope of the disclosure. Further, elements of any embodiment may be added and/or combined with any elements of another embodiment.

Embodiments of the present disclosure may be used in connection with any structure, including, but not limited to, homes, offices, businesses, schools, churches, sporting complexes, hospitals, shopping centers, and manufacturing facilities. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

We claim:

1. A computer-implemented method for configuring a building automation system, the method comprising:
obtaining a parameter for a building in which an automation system is to be installed within the building;
receiving input for configuring a first component of the automation system and a second component of the automation system being installed, the input including a first location for installing the first component and a second location for installing the second component within the building; identifying each of the first and second components of the automation system based on the input received;
obtaining configuration information for properly configuring each of the identified first and second components of the automation system being installed in accordance with the obtained parameter for the building;
determining whether or not each of the first and second components of the automation system being installed within the building is properly configured based on the obtained configuration information and the input received indicating the first and second location of the respective first and second components; and
providing a notification indicating results of the determination for one or more of the first and second components, wherein options are presented for modifying configuration settings for one or more of the first and second components.

2. The method of claim 1, further comprising:
receiving additional input for configuring a third component of the automation system to be installed within the building;
identifying the third component of the automation system based on the additional input; and
obtaining configuration information for properly configuring the identified third component of the automation system based at least in part on the parameter obtained for the building.

3. The method of claim 2, wherein the obtained configuration information for the third component specifies an association between the third component and the first component of the automation system, and the method further comprises:
determining whether the first and third components of the automation system are properly configured based on the obtained configuration information and the input received for configuring each of the first and third components; and
providing a notification indicating results of the determination for the first and third components.

4. The method of claim 3, wherein determining whether the first and third components of the automation system are properly configured comprises:
comparing the obtained configuration information for the third component with the input received for configuring the third component; and
determining whether or not the association between the first and third components is configured properly based on the comparison.

5. The method of claim 1, wherein the parameter for the building is included within a digital blueprint for the building, the digital blueprint indicating proper locations for the first and second components to be installed within the building.

6. The method of claim 5, further comprising:
displaying a graphical representation of the digital blueprint via a display device coupled to a mobile device, the graphical representation including visual indicators representing the first and second components at positions corresponding to the proper locations of the first and second components to be installed within the building.

7. The method of claim 6, wherein the graphical representation of the digital blueprint displayed includes a visual indication of a user's current position within the building.

8. The method of claim 7, wherein the visual indication of the user's current position is based on a current geographic location of the user's mobile device within the building.

9. The method of claim 8, wherein the current geographic location of the user's mobile device is based on location data derived from one or more sensors of the user's mobile device.

10. The method of claim 1, wherein the input from the user includes a first identifier for the first component and a second identifier for the second component.

11. The method of claim 10, wherein each of the first and second identifiers is an electronic serial number corresponding to each of the first and second components.

12. The method of claim 11, wherein the electronic serial number for each of the first and second components is based on identifier information captured by the user's mobile device using one or more input devices coupled to the user's mobile device.

13. The method of claim 12, wherein the one or more input devices include a touchscreen display, an infrared (IR) scanner, a digital camera, an RFID tag reader, and an NFC tag reader.

14. A system for configuring a building automation system, the system comprising:
a memory having processor-readable instructions stored therein;
a processor configured to access the memory and execute the processor-readable instructions, which when executed by the processor cause the processor to perform a plurality of functions, including functions to: obtain a parameter for a building in which an automation system is to be installed within the building; receive input for configuring a first component of the automation system and a second component of the automation system being installed, the input including a first location for installing the first component and a second location for installing the second component within the building; identify each of the first and second components of the automation system based on the input received; obtain configuration information for properly configuring each of the identified first and second components of the automation system being installed in accordance with the obtained parameter for the building; determine whether or not each of the first and second components of the automation system being installed within the building is properly configured based on the obtained configuration information and the input received from the user indicating the first and second location of the respective first and second components; and
provide a notification indicating results of the determination for one or more of the first and second components, wherein options for modifying configuration settings for one or more of the first and second components are presented.

15. The system of claim 14, wherein the processor is further configured to perform functions to:
receive additional input for configuring a third component of the automation system to be installed within the building;
identify the third component of the automation system based on the additional input received; and
obtain configuration information for properly configuring the identified third component of the automation system based at least in part on the parameter obtained for the building.

16. The system of claim 15, wherein the obtained configuration information for the third component specifies an association between the third component and the first component of the automation system, and the processor is further configured to perform functions to:
determine whether the first and third components of the automation system are properly configured based on the obtained configuration information and the input received for configuring each of the first and third components; and
provide a notification indicating results of the determination for the first and third components.

17. The system of claim 16, wherein the processor is configured to perform functions to:
compare the obtained configuration information for the third component with the input received from the user for configuring the third component; and
determine whether or not the association between the first and third components is configured properly based on the comparison.

18. The system of claim 17, wherein the parameter for the building is included within a digital blueprint for the building, the digital blueprint indicating locations for the first and second components to be installed within the building, and the processor is further configured to perform functions to:
display a graphical representation of the digital blueprint to a user via a display device coupled to a mobile device of the user, the graphical representation including visual indicators representing the first and second components at positions corresponding to the proper locations of the first and second components to be installed within the building.

19. The system of claim 18, wherein the graphical representation of the digital blueprint displayed includes a visual indication of the user's current position within the building.

20. The system of claim 19, wherein the visual indication of the user's current position is based on a current geographic location of the user's mobile device within the building, and the current geographic location of the user's mobile device is based on location data derived from one or more sensors of the user's mobile device.

21. The system of claim 20, wherein the input from the user includes a first identifier for the first component and a second identifier for the second component, and the identifying step includes retrieving information from a remote database.

22. The system of claim 20, where the first identifier and second identifier correspond to positions the first and second device occupy in a package.

23. The system of claim 14, wherein the first and second identifiers are electronic serial numbers corresponding to each of the first and second device, wherein the electronic serial number for each of the first and second components is captured by the user's mobile device using one or more input devices coupled to the user's mobile device.

24. The system of claim 23, wherein the one or more input devices include a touchscreen display, an infrared (IR) scanner, a digital camera, an RFID tag reader, and an NFC tag reader.

25. A non-transitory computer readable storage medium storing instructions that, when executed by a computer, cause the computer to perform functions to:
obtain a parameter for a building in which an automation system is to be installed within the building;
receive input for configuring a first component of the automation system and a second component of the automation system being installed, the input including a first location for installing the first component and a second location for installing the second component within the building;
identify each of the first and second components of the automation system based on the input received;
obtain configuration information for properly configuring each of the identified first and second components of the automation system being installed in accordance with the obtained parameter for the building;
determine whether or not each of the first and second components of the automation system being installed within the building is properly configured based on the obtained configuration information and the input received indicating the first and second location of the respective first and second components; and
provide a notification indicating results of the determination for one or more of the first and second components, wherein the user is presented with options for modifying configuration settings for one or more of the first and second components.

26. A method for providing a graphical user interface for configuring a building automation system, the method comprising:
obtaining a parameter for a building in which an automation system is to be installed within the building that is repented on the graphical user interface;
visually indicating on the graphical user interface a selection of components of the automation system being installed for configuration within the building automation system;
selecting one or more components for configuration;
receiving input for configuring the selected one or more components, the input including the location for installing for the one or more components;
obtaining configuration information for properly configuring the selected one or more components;
displaying associations between the selected one or more components and other components of the building automation system; and
presenting options for modifying configuration settings for the selected one or more components.

27. The method of claim 26, wherein the options presented for modifying configuration settings for the selected one or more components includes one or more of the following: add one or more components of the automation system being installed for configuration within the building automation system; delete one or more components of the automation system being installed for configuration within the building automation system; change the associations between the selected one or more components and other components of the building automation system; and/or move the selected one or more components to a different location.

28. A method for providing a graphical user interface of claim 26, further comprising:
displaying a digital blueprint of the building as the parameter for the building;
wherein the digital blueprint indicates a location for the selected one or more components to be installed within the building;
displaying a corresponding symbol for each of the one or more components at the indicated location;
wherein each of the one or more components can be moved to different a location, by dragging and dropping the corresponding symbol to another location within the electronic blueprint displayed on the graphical user interphase.

29. A method for providing a graphical user interface for configuring a group of components of a building automation system to be installed, the method comprising:
displaying a list of components to be installed within an identified group for configuration;
displaying component symbols that graphically represents each of the components in the identified group;
associating each of the listed component from the identified group with the corresponding component symbol graphically represented; and
presenting options for modifying configuration settings for each of the listed component within the identified group.

30. A nontransitory computer readable storage medium storing instructions to perform a method for providing a graphical user interphase on a display, the method comprising:
obtaining a parameter for a building in which an automation system is to be installed within the building that is repented on the graphical user interface;
visually indicating on the graphical user interface a selection of components of the automation system being installed for configuration within the building automation system;
selecting one or more components for configuration;
receiving input for configuring the selected one or more components, the input including the location for installing for the one or more components;
obtaining configuration information for properly configuring the selected one or more components;
displaying associations between the selected one or more components and other components of the building automation system; and
presenting options for modifying configuration settings for the selected one or more components.
